(19) United States
(12) Patent Application Publication
(10) Pub. No.: US 2026/0225943 A1
(43) Pub. Date: Aug. 6, 2026

(54) Privacy Glass With Chromium

(71) Applicant: Vitro Flat Glass LLC, Cheswick, PA (US)

(72) Inventor: José Guadalupe Cid Aguilar, Nuevo León (MX)

(21) Appl. No.: 19/463,233

(22) Filed: Jan. 29, 2026

Related U.S. Application Data
(60) Provisional application No. 63/751,957, filed on Jan. 31, 2025.

(51) Int. Cl. C03C 4/02; B32B 17/06; C03B 18/02; C03C 3/11; C03C 4/08

(52) U.S. Cl. CPC C03C 4/02; B32B 17/06; C03C 3/111; C03C 4/082; C03C 4/085; B32B 2250/03; B32B 2250/40; C03B 18/02

(57) ABSTRACT

The present invention relates to a glass with low transmittance, of a neutral gray color and more specifically to a gray glass composition to produce glass for use in the automotive industry that can be utilized in various applications including, but not limited to, applications where a privacy glass is desired, and additionally for use in the manufacture of both laminated and temperate panoramic roofs, rear windows and rear doors.

### RELATED APPLICATION DATA

The present application claims priority to, and is a non-provisional of, U.S. Provisional Patent Application No. 63/751,957, filed Jan. 31, 2025, the disclosure of which is hereby incorporated by reference in its entirety.

### BACKGROUND OF THE INVENTION

### Field of the Invention

The present invention relates to a glass with low transmittance, of a neutral gray color and more specifically to a gray glass composition to produce glass for use in the automotive industry that can be utilized in various applications including, but not limited to, applications where a privacy glass is desired, and additionally for use in the manufacture of both laminated and temperate panoramic roofs, rear windows and rear doors.

### Description of the Related Art

Colored glass is a material to which, during the fusion process, metal oxides are incorporated. As a result of previous research, it is known that the addition of iron-cobalt oxides in combination with selenium gives the glass shades from greenish gray—neutral gray to yellowish gray depending on the ratio thereof. By increasing the concentrations of iron oxide, cobalt oxide and selenium and controlling the redox conditions in the glass melting atmosphere and/or in the mixture (mainly carbon and sodium nitrate concentration), a glass with low light transmission, good direct solar transmission blocking and privacy gray coloration, which is widely used in roofs, rear windows and rear doors of motor vehicles can be obtained.

Solar control is the ability to modify the amount of solar radiation transmitted or reflected, in the spectral ranges of near ultraviolet (UV; 300-380 nm), visible (VIS; 380-780 nm) and infrared (IR; 780-2500 nm). In its automotive use, this is achieved with the addition of various absorbent coloring agents in the initial mixture, so that the glass has properties to absorb both infrared (IR) and ultraviolet (UV) solar radiation, to reduce the passage of excess heat towards the interior of the vehicle caused by radiation from the sun, as well as to protect the interiors from the degradation of UV radiation coming therefrom.

The glasses described in almost all patents that refer to a type of neutral gray glass are based on three main dyes: iron oxide, cobalt oxide and selenium, whose main function is to provide solar control properties to the glass.

The following prior art patents use various metal oxides as main dyes to obtain a gray glass and provide the final characteristics of the product. These components, such as nickel oxide, manganese oxide, chromium oxide or rare earth oxides, are mixed in a base formulation of a silica-sodium-calcium glass.

For example, U.S. Pat. No. 5,352,640 (U.S. Pat. No. RE37,998) mentions the obtaining of gray glasses used mainly in the automotive industry, whose composition of coloring agents ranges from 1.4 to 4% of iron oxide (Fe₂O₃) and from 0 to 0.05% of cobalt oxide, with around 0.02% of excess cobalt oxide when Fe₂O₃ is less than 2%, optionally having a combination of CoO+Se+Cr₂O₃ with a content of less than 0.24% by weight. The physical properties of the glass such as light transmission and energy transmission are equal to or less than 20% under illuminant A and equal to or less than 12% at a thickness of 3.85 mm, respectively.

U.S. Pat. No. 5,545,596 discloses the use of dyes is mentioned in concentrations of 0.45 to 2.5% for Fe₂O₃ (total iron), from 0.001 to 0.02% for CoO, from 0 to 0.0025% for Se and from 0 to 0.1% for Cr₂O₃, for gray glass having a light transmission with illuminant A of 20 to 60%, used in side and rear windows for vehicles.

U.S. Pat. No. 7,393,802 describes the use of Fe₂O₃, CoO, Se and NiO as dyes, but also adds the use of CeO₂ and TiO₂ in amounts no greater than 2.0% by weight to increase ultraviolet absorption.

For the glasses obtained in U.S. Pat. No. 7,622,410 nickel oxide is used in concentrations of 500 to 1000 ppm, erbium oxide from 0.1 to 0.8% and chromium oxide in contents of 1 to 20 ppm, in addition to a total content of iron oxide of 0.15 to 0.45%, selenium less than or equal to 3 ppm and cobalt oxide of 120 to 240 ppm. The mixture of these oxides is used for the general adjustment of the gray coloration of the glass. The light transmission of the glass of this patent is 8 to 25%, with a dominant wavelength of 435 to 570 nm, using a cobalt oxide/nickel oxide ratio of 0.22 to 0.30 and FeO/Fe₂O₃ redox values of from 0.20 to 0.40.

The main disadvantage of these glasses is the high cost of using rare earth oxides in their composition.

In U.S. Pat. No. 8,017,538 the glasses disclosed are known to use nickel oxide in concentrations of 400 to 700 ppm or 1500 to 1900 ppm, iron oxide 0.7 to 0.95% with a redox value of 0.40 or less, plus cobalt oxide at 200 to 300 ppm, to obtain a gray color adjustment and obtain the following physical properties: light transmission under illuminant A (T_{LA}) of 50% or less and an average energy transmission (Te) less than 45%, for a glass thickness of 3.85 mm.

The use of nickel oxide, used as a dye in some of the previous patents, has the disadvantage that nickel sulfide inclusions can form (a defect that is not easily detectable) that can cause the glass sheets to break due to the difference in the thermal expansion coefficient of this material with the rest of the glass matrix.

The glasses described in U.S. Pat. No. 8,551,899 have a dark gray-neutral green color, given by the dyes used such as Fe₂O₃ in 1.4 to 2.5%, CoO from 0.02 to 0.04%, Se from 0.0001 to 0.004%, MnO from 0.005 to 0.5 and CeO from 0.05 to 1% with alight transmission of illuminant A less than 15%. These glasses are used as privacy glass or panoramic roofs in automobiles, as well as used in construction.

U.S. Pat. No. 7,754,632 uses concentrations of MnO up to 600 ppm and TiO₂ less than 0.1% in addition of other oxides such as Fe₂O₃ 1.1 to 1.5% (total iron), Co 150 to 200 ppm, Cr₂O₃ 25 at 100 ppm and Se 10 at 50 ppm, to achieve optical characteristics of light transmission of illuminant A less than 20% for thicknesses of 4 mm.

U.S. Pat. No. 8,785,338 refers to a composition of a silica-sodium-calcium glass with contents of 0.70 to 1.70% by mass of Fe₂O₃ (total iron), 0.15 to 0.45% by mass of FeO (oxide ferrous), 0-0.8% by mass of TiO₂, 100 to 350 ppm of CoO, 0 to 60 ppm of Se, 100 to 700 ppm of Cr₂O₃ and 3 to 150 ppm of MnO, which has a ratio (Fe²⁺/Fe³⁺) of ferrous ion to ferric ion of from 0.20 to 0.80. This patent claims that this glass has superior ultraviolet radiation absorption and infrared radiation absorption performance (thermal insulation performance), as well as adequate transparency, achieved thanks to the use of TiO₂ preferably in ranges from 0 to 0.5%.

U.S. Pat. No. 9,120,695 features the following glass composition: 1.4 to 2% Fe₂O₃ with an FeO content of 10 to 30% (with respect to total iron), 0.02 to 0.035% CoO, 0.0015 to 0.004% Se and 0.005 to 0.5% MnO. Optical characteristics of light transmission of illuminant A of less than 15% and ultraviolet ray transmission of 2% or less are reported.

The dark green glasses of U.S. Pat. No. 9,617,182 uses as dye 1.2 to 2% of total Fe₂O₃, 0.0220 to 0.04% of CoO, 0.002 to 0.0035% of Se and 0.01 to 0.04% of Cr₂O₃, wherein the weight ratio of (CoO+Cr₂O₃) to Se (=[CoO+Cr₂O₃]/Se) is 13 to 25 and the weight ratio of CoO to Cr₂O₃ (=CoO/Cr₂O₃) is 0.9 to 1.8. The glass exhibits a visible light transmittance (T_{LA}) of 15% or less, a direct solar energy transmittance (T_{DS}) of 16% or less, and an ultraviolet radiation transmittance (T_{UV}) of 3% or less, when measured for a 4 mm reference thickness.

U.S. Pat. No. 7,902,097 uses concentrations of: 0 to 30 ppm of Co₃O₄, 1 to 20 ppm of Se, 20 to 200 ppm of CuO and 0.30 to 0.70% of Fe₂O₃ to obtain a neutral gray glass, with optical characteristics of light transmission with illuminant A greater than 65%, total solar energy transmission equal to or less than 60%, ultraviolet radiation transmission less than 46% and a dominant wavelength of 490 to 600 nm. This patent adds components such as carbon from 0.01 to 0.07% or sodium nitrate from 0.2 to 1.2% for modifying the redox state of iron and copper oxide, since, in combination with the other dyes, it is used as an alternative to obtain the gray tone, partially replacing the addition of titanium oxide and cobalt oxide.

Various articles have also described the importance of the balance between ferrous and ferric oxides in glasses, such as the one written by N. E. Densem (“The equilibrium between ferrous and ferric oxides in glasses”, Journal of the Society of Glass Technology, Glasgow, England, May 1937, pp. 374-389); and J. C. Hostetter and H. S. Roberts, (“Note on the dissociation of Ferric Oxide dissolved in glass and its relation to the color of iron-bearing glasses”; Journal of the American Ceramic Society, USA, September, 1921, pp. 927-938). Additionally, many books and scientific articles have been published on the composition of colored glass with infrared and ultraviolet radiation absorption characteristics.

C. R. Bamford, in the book “Color Generation and Control in Glass, Glass Science and Technology” (Elsevier Science Publishing Co., Amsterdam, 1977) describes the principle of glass coloring methods and applications. In this book the author considers that three elements govern the color of the light transmitted by a glass, being the color of the incident light, the interaction of the glass with that light and the interaction of the transmitted light with the eye of the observer. The procedures require the spectral transmission data of the glass with the corresponding glass thickness and viewing angle.

With respect to titanium oxide (TiO₂) in silica-sodium-calcium glasses, the most stable form of titanium in glasses is the tetravalent (Ti⁴⁺). The trivalent form could confer coloration however, this effect is not observed in silica-sodium-calcium glass. In the document “Effects of titanium dioxide on glass” written by Beals M D (see The Glass Industry, September 1963, pp 495-531) the author describes the interest that titanium dioxide has been shown as a glass component. The effects produced by the use of titanium dioxide include comments that TiO₂ greatly increases the refractive index, increases the absorption of light in the ultraviolet region, and that viscosity and surface tension are reduced. From data on the use of titanium dioxide in enamels, it was observed that TiO₂ increases chemical durability and acts as a flux. In general, clear glasses containing titanium dioxide can be found in all common glass-forming systems (borates, silicates and phosphates). The various glass-forming regions for titanium dioxide-containing systems are not grouped together in one place, as the organization of the discussion is based more on the properties of a use of titanium dioxide-containing glasses rather than their own constitution.

On the other hand, the addition of selenium to silica-sodium-calcium glass can produce a pink color due to the presence of atomic selenium. Selenium is one of the most used physical bleaches for glass with traces of iron coming as an undesirable impurity in the raw materials, because its coloring neutralizes the ferrous and ferric ions present in the glass.

The combination of iron oxide and selenium in silica-sodium-calcium glass confers a reddish-brown coloration and a decrease in light transmission, due to an absorption band located in the visible region between 490 nm and 500 nm (band similar to atomic selenium). This band extends towards the ultraviolet region, also causing a decrease in this type of transmission in the glass. The intensity of the coloration and the final properties of a glass are a function of the concentration of iron oxide and selenium in the glass.

It is well known that copper has played an important aspect in the production of glass, ceramics and colored pigments. For example, the coloring of Persian ceramics has been recognized by its tone conferred by copper. Of special interest to ceramic artists are turquoise blue and especially dark Egyptian and Persian blue (Waldemar A. Weil; Colored Glasses, Society of Glass Technology, Great Britain, pp. 154-167, 1976).

Copper has been used in glass compositions, not only in those of the silica-sodium-calcium type, but in some others, such as those that contain, for example, borosilicate. Therefore, the color developed depends on the base of the glass, its concentration and its oxidation state.

In the case of a sodium-silica-calcium base glass, copper in oxide form imparts a blue coloration of a greenish tone, specifically turquoise, however, in glass, copper can be in its monovalent state, which does not impart color. Thus, the blue-green coloration depends not only on the amount of copper present, but also on the ionic balance between the cuprous and cupric states. The maximum absorption of copper oxide is found in a band centered at 780 nm and a secondary weak maximum peak is present at 450 nm, which disappears at high soda contents (around 40 weight percent) (C. R. Bamford Color Generation and Control in Glass, Glass Science and Technology, Elsevier Scientific Publishing Company, pp. 48-50, Amsterdam, 1977).

Glass can also be manufactured in smaller thicknesses, as is the case with glass used in the manufacture of laminated systems. If higher concentrations of CuO are present, during the formation process within the float chamber, a reduction process attributable to the process atmosphere could occur, with the presence of a reddish color on the glass surface, which is observed in reflection. This effect is related to the residence time and the advancing speed of the glass ribbon, which means that, at lower speeds, it will be necessary to reduce the CuO content in glass or adjust the reducing conditions in the float chamber.

While various types of privacy glasses are known in the art as well as various glass that have a range of color profiles and light transmittance properties are available, none to date have been able to realize a glass composition that has both a very low level of light transmittance in combination with a desirable color profile.

### SUMMARY OF THE INVENTION

The invention relates to a glass having a visible light transmission (T_{LA}) in the range of equal to or greater than 8 percent and equal to or less than 22 percent at a glass thickness of 3.85 mm via T_{LA} CIE Illuminant A across wavelengths 380 nm to 780 nm, an a* in the range of −4 to 0, and a b* in the range of −1 to 7.

The invention further relates to a method of making a glass by, among other things, providing a glass batch that has a visible light transmission (T_{LA}) in the range of equal to or greater than 6 percent and equal to or less than 25 percent, or even equal to or greater than 7 percent and equal to or less than 24 percent, or even equal to or greater than 8 percent and equal to or less than 23 percent, or even equal to or greater than 9 percent and equal to or less than 22 percent, at a glass thickness of 3.85 mm via T_{L}A CIE Illuminant A across wavelengths 380 nm to 780 nm, an a* in the range of −4 to 0, or an a* in the range of −3.5 to −0.25, or an a* in the range of −3 to −0.5, or even an a* in the range of −2.5 to −0.75, and a b* in the range of −1 to 7, or a b* in the range of −0.5 to 6.5, or a b* in the range of 0 to 6, or even a b* in the range of 0.5 to 5.5.

Further non-limiting embodiments or aspects are set forth and described in the following clauses.

Clause 1: A glass comprising 64 weight percent to 75 weight percent SiO₂, or even 68 weight percent to 75 weight percent SiO₂; 10 weight percent to 20 weight percent Na₂O, or even 10 weight percent to 18 weight percent Na₂O; 5 weight percent to 15 weight percent CaO; 0 weight percent to 10 weight percent MgO; 0 weight percent to 5 weight percent Al₂O₃; 0 weight percent to 5 weight percent K₂O; 0 weight percent to 1 weight percent SO₃, or even 0.05 weight percent to 0.3 weight percent SO₃; and 1 weight percent to 3.5 weight percent total iron, preferably 1.25 weight percent to 3 weight percent total iron, or even more preferably 1.5 weight percent to 2.5 weight percent total iron, wherein the glass has a visible light transmission (T_{LA}) in the range of equal to or greater than 6 percent and equal to or less than 25 percent, or even equal to or greater than 7 percent and equal to or less than 24 percent, or even equal to or greater than 8 percent and equal to or less than 23 percent, or even equal to or greater than 9 percent and equal to or less than 22 percent, at a glass thickness of 3.85 mm via T_{LA} CIE Illuminant A across wavelengths 380 nm to 780 nm, an a* in the range of −4 to 0, or an a* in the range of −3.5 to −0.25, or an a* in the range of −3 to −0.5, or even an a* in the range of −2.5 to −0.75, and a b* in the range of −1 to 7, or a b* in the range of −0.5 to 6.5, or a b* in the range of 0 to 6, or even a b* in the range of 0.5 to 5.5.

Clause 2: The glass of clause 1, wherein the glass comprises a redox ratio in the range of 0.1 to 0.3.

Clause 3: The glass of any of clauses 1 or 2, wherein the glass comprises a redox ratio in the range of 0.13 to 0.28, or even in the range of 0.18 to 0.22.

Clause 4: The glass of any of clauses 1 to 3, wherein the glass has an ultraviolet transmittance (T_{UV}) of equal to or less than 10 percent, of equal to or less than 9 percent, of equal to or less than 8 percent, of equal to or less than 7 percent, or even of equal to or less than 6 percent at a glass thickness of 3.85 mm at a wavelength range of 300 nm to 400 nm using the ISO 13837 standard.

Clause 5: The glass of any of clauses 1 to 4, wherein the glass has a direct solar energy transmission (T_{DS}) of equal to or less than 20 percent, equal to or less than 18 percent, equal to or less than 16 percent, or even less than 13 percent in the range of 300 to 2500 nm with intervals of 5, 10 and 50 nm, according to the ISO 13837 standard. In another embodiment, the glass of any of clauses 1 to 4 has a T_{DS} in the range of 5 percent to 20 percent, or in the range of 6 percent to 18 percent, or even in the range of 7 percent to 15 percent in the range of 300 to 2500 nm with intervals of 5, 10 and 50 nm, according to the ISO 13837 standard.

Clause 6: The glass of any of clauses 1 to 5, wherein the glass has an infrared transmittance (T_{IR}) of equal to or less than 18 percent, equal to or less than 16 percent, equal to or less than 15 percent, equal to or less than 13 percent, equal to or less than 12 percent, equal to or less than 11 percent, or even equal to or less than 10 percent, when measured over the wavelength range of 800 nm to 2500 nm using the ISO 13837 standard.

Clause 7: The glass of any of clauses 1 to 6, wherein the glass has a total solar energy transmittance (T_{TS}) of equal to or less than 50 percent, of equal to or less than 45 percent, of equal to or less than 40 percent, of equal to or less than 35 percent, of equal to or less than 30 percent, of equal to or less than 25 percent, or even of equal to or less than 20 percent at a glass thickness of 3.85 mm, when measured using the ISO 13837 standard.

Clause 8: The glass of any of clauses 1 to 7, wherein the glass has a dominant wavelength of 490 nm to 570 nm when it has a nominal thickness of 3.85 mm and is manufactured by a float process.

Clause 9: The glass of any of clauses 1 to 8, wherein the glass has a purity in the range of 0.4 percent to 12 percent, or in the range of 0.6 percent to 11 percent, or in the range of 0.8 percent to 10 percent, or even in the range of 1 percent to 9 percent.

Clause 10: The glass of any of clauses 1 to 9, wherein the glass further comprises 0.02 weight percent to 0.04 weight percent Co₃O₄, or from 0.021 weight percent to 0.039 weight percent Co₃O₄, or even from 0.022 weight percent to 0.038 weight percent Co₃O₄.

Clause 11: The glass of any of clauses 1 to 10, wherein the glass further comprises 0.0001 weight percent to 0.02 weight percent CuO, or from 0.005 weight percent to 0.01 weight percent CuO, or even from 0.001 weight percent to 0.008 weight percent CuO.

Clause 12: The glass of any of clauses 1 to 11, wherein the glass further comprises 0.002 weight percent to 0.005 weight percent selenium (Se), or from 0.0022 weight percent to 0.0045 weight percent selenium, or from 0.0024 weight percent to 0.004 weight percent selenium, or even from 0.0026 weight percent to 0.0035 weight percent selenium.

Clause 13: The glass of any of clauses 1 to 12, wherein the glass further comprises 0.01 weight percent to 0.15 weight percent TiO₂, or from 0.02 weight percent to 0.1 weight percent TiO₂, or even from 0.03 weight percent to 0.09 weight percent TiO₂.

Clause 14: The glass of any of clauses 1 to 13, wherein the glass further comprises 0.25 weight percent to 0.5 weight percent FeO, or from 0.3 weight percent to 0.45 weight percent FeO, or even from 0.35 weight percent to 0.49 weight percent FeO.

Clause 15: The glass of any of clauses 1 to 14, wherein the glass further comprises 0.1 weight percent to 0.25 weight percent SO₃, or from 0.12 weight percent to 0.23 weight percent SO₃, or even from 0.14 weight percent to 0.21 weight percent SO₃.

Clause 16: The glass of any of clauses 1 to 15, wherein the glass further comprises 0.1 weight percent to 0.7 weight percent sodium nitrate (NaNO₃), or from 0.25 weight percent to 0.65 weight percent NaNO₃, or even from 0.35 weight percent to 0.55 weight percent NaNO₃.

Clause 17: The glass of any of clauses 1 to 16, wherein the glass further comprises either no added coal or other carbon source (that is zero weight percent), or from 0.01 weight percent to 0.04 weight percent coal or other carbon source, or from 0.015 weight percent to 0.035 weight percent coal or other carbon source, or even from 0.02 weight percent to 0.03 weight percent coal or other carbon source.

Clause 18: The glass of any of clauses 1 to 17, wherein the glass further comprises 0.0005 weight percent (5 ppm) to 0.01 weight percent (100 ppm) Cr₂O₃, or from 0.001 weight percent (10 ppm) to 0.009 weight percent (90 ppm) Cr₂O₃, 0.002 weight percent (20 ppm) to 0.008 weight percent (80 ppm) Cr₂O₃, or even from 0.003 weight percent (30 ppm) to 0.007 weight percent (70 ppm) Cr₂O₃.

Clause 19: The glass of any of clauses 1 to 18, wherein the glass has a gray color as determined by the naked eye.

Clause 20: The glass of any of clauses 1 to 19, wherein the glass is used in one or more of an architectural transparency or a vehicle transparency; or wherein the glass is used in one or more of an architectural transparency or a vehicle transparency, and wherein the architectural transparency or the vehicle transparency comprises one or more low-e coatings, one or more anti-reflective coatings, one or more solar control coatings, one or more low UV and/or IRC coatings, or combinations of any two or more thereof.

Clause 21: A method of making a glass using a conventional float non-vacuum glass system, comprising the steps of melting a glass batch to provide a pool of molten glass; flowing the pool of molten glass onto a molten tin bath; moving the molten glass on the surface of the molten tin bath, while controllably cooling the molten glass and applying forces to the molten glass to provide a glass of a desired thickness; and removing the glass from the molten tin bath, wherein the glass comprises 64 weight percent to 75 weight percent SiO₂, or even 68 weight percent to 75 weight percent SiO₂; 10 weight percent to 20 weight percent Na₂O, or even 10 weight percent to 18 weight percent Na₂O; 5 weight percent to 15 weight percent CaO; 0 weight percent to 10 weight percent MgO; 0 weight percent to 5 weight percent Al₂O₃; 0 weight percent to 5 weight percent K₂O; 0 weight percent to 1 weight percent SO₃, or even 0.05 weight percent to 0.3 weight percent SO₃; and 1 weight percent to 3.5 weight percent total iron, preferably 1.25 weight percent to 3 weight percent total iron, or even more preferably 1.5 weight percent to 2.5 weight percent total iron, wherein the glass has a visible light transmission (T_{LA}) in the range of equal to or greater than 6 percent and equal to or less than 25 percent, or even equal to or greater than 7 percent and equal to or less than 24 percent, or even equal to or greater than 8 percent and equal to or less than 23 percent, or even equal to or greater than 9 percent and equal to or less than 22 percent, at a glass thickness of 3.85 mm via T_{LA} CIE Illuminant A across wavelengths 380 nm to 780 nm, an a* in the range of −4 to 0, or an a* in the range of −3.5 to −0.25, or an a* in the range of −3 to −0.5, or even an a* in the range of −2.5 to −0.75, and a b* in the range of −1 to 7, or a b* in the range of −0.5 to 6.5, or a b* in the range of 0 to 6, or even a b* in the range of 0.5 to 5.5.

Clause 22: The method of clause 21, wherein the glass comprises a redox ratio in the range of 0.1 to 0.3.

Clause 23: The method of any of clauses 21 or 22, wherein the glass comprises a redox ratio in the range of 0.13 to 0.28, or even in the range of 0.18 to 0.22.

Clause 24: The method of any of clauses 21 to 23, wherein the glass has an ultraviolet transmittance (T_{UV}) of equal to or less than 10 percent, of equal to or less than 9 percent, of equal to or less than 8 percent, of equal to or less than 7 percent, or even of equal to or less than 6 percent at a glass thickness of 3.85 mm at a wavelength range of 300 nm to 400 nm using the ISO 13837 standard.

Clause 25: The method of any of clauses 21 to 24, wherein the glass has a direct solar energy transmission (T_{DS}) of equal to or less than 20 percent, equal to or less than 18 percent, equal to or less than 16 percent, or even equal to or less than 13 percent in the range of 300 to 2500 nm with intervals of 5, 10 and 50 nm, according to the ISO 13837 standard. In another embodiment, the glass of any of clauses 21 to 24 has a T_{DS} in the range of 5 percent to 20 percent, or in the range of 6 percent to 18 percent, or even in the range of 7 percent to 15 percent in the range of 300 to 2500 nm with intervals of 5, 10 and 50 nm, according to the ISO 13837 standard.

Clause 26: The method of any of clauses 21 to 25, wherein the glass has an infrared transmittance (T_{IR}) of equal to or less than 18 percent, equal to or less than 16 percent, equal to or less than 15 percent, equal to or less than 13 percent, equal to or less than 12 percent, equal to or less than 11 percent, or even equal to or less than 10 percent, when measured over the wavelength range of 800 nm to 2500 nm using the ISO 13837 standard.

Clause 27: The method of any of clauses 21 to 26, wherein the glass has a total solar energy transmittance (T_{TS}) of equal to or less than 50 percent, of equal to or less than 45 percent, of equal to or less than 40 percent, of equal to or less than 35 percent, of equal to or less than 30 percent, of equal to or less than 25 percent, or even of equal to or less than 20 percent at a glass thickness of 3.85 mm, when measured using the ISO 13837 standard.

Clause 28: The method of any of clauses 21 to 27, wherein the glass has a dominant wavelength of 490 nm to 570 nm when it has a nominal thickness of 3.85 mm and is manufactured by a float process.

Clause 29: The method of any of clauses 21 to 28, wherein the glass has a purity in the range of 0.4 percent to 12 percent, or in the range of 0.6 percent to 11 percent, or in the range of 0.8 percent to 10 percent, or even in the range of 1 percent to 9 percent.

Clause 30: The method of any of clauses 21 to 29, wherein the glass further comprises 0.02 weight percent to 0.04 weight percent Co₃O₄, or from 0.021 weight percent to 0.039 weight percent Co₃O₄, or even from 0.022 weight percent to 0.038 weight percent Co₃O₄.

Clause 31: The method of any of clauses 21 to 30, wherein the glass further comprises 0.0001 weight percent to 0.02 weight percent CuO, or from 0.005 weight percent to 0.01 weight percent CuO, or even from 0.001 weight percent to 0.008 weight percent CuO.

Clause 32: The method of any of clauses 21 to 31, wherein the glass further comprises 0.002 weight percent to 0.005 weight percent selenium (Se), or from 0.0022 weight percent to 0.0045 weight percent selenium, or from 0.0024 weight percent to 0.004 weight percent selenium, or even from 0.0026 weight percent to 0.0035 weight percent selenium.

Clause 33: The method of any of clauses 21 to 32, wherein the glass further comprises 0.01 weight percent to 0.15 weight percent TiO₂, or from 0.02 weight percent to 0.1 weight percent TiO₂, or even from 0.03 weight percent to 0.09 weight percent TiO₂.

Clause 34: The method of any of clauses 21 to 33, wherein the glass further comprises 0.25 weight percent to 0.5 weight percent FeO, or from 0.3 weight percent to 0.45 weight percent FeO, or even from 0.35 weight percent to 0.49 weight percent FeO.

Clause 35: The method of any of clauses 21 to 34, wherein the glass further comprises 0.1 weight percent to 0.25 weight percent SO₃, or from 0.12 weight percent to 0.23 weight percent SO₃, or even from 0.14 weight percent to 0.21 weight percent SO₃.

Clause 36: The method of any of clauses 21 to 35, wherein the glass further comprises 0.1 weight percent to 0.7 weight percent sodium nitrate (NaNO₃), or from 0.25 weight percent to 0.65 weight percent NaNO₃, or even from 0.35 weight percent to 0.55 weight percent NaNO₃.

Clause 37: The method of any of clauses 21 to 36, wherein the glass further comprises either no added coal or other carbon source (that is zero weight percent), or from 0.01 weight percent to 0.04 weight percent coal or other carbon source, or from 0.015 weight percent to 0.035 weight percent coal or other carbon source, or even from 0.02 weight percent to 0.03 weight percent coal or other carbon source.

Clause 38: The method of any of clauses 21 to 37, wherein the glass further comprises 0.0005 weight percent (5 ppm) to 0.01 weight percent (100 ppm) Cr₂O₃, or from 0.001 weight percent (10 ppm) to 0.009 weight percent (90 ppm) Cr₂O₃, 0.002 weight percent (20 ppm) to 0.008 weight percent (80 ppm) Cr₂O₃, or even from 0.003 weight percent (30 ppm) to 0.007 weight percent (70 ppm) Cr₂O₃.

Clause 39: The method of any of clauses 21 to 38, wherein the glass has a gray color as determined by the naked eye.

Clause 40: The method of any of clauses 21 to 39, wherein the glass is used in one or more of an architectural transparency or a vehicle transparency; or wherein the glass is used in one or more of an architectural transparency or a vehicle transparency, and wherein the architectural transparency or the vehicle transparency comprises one or more low-e coatings, one or more anti-reflective coatings, one or more solar control coatings, one or more low UV and/or IRC coatings, or combinations of any two or more thereof.

Clause 41: A laminate comprising a first ply comprising a first surface and a second surface opposite the first surface, wherein the first surface comprises an outer surface of the laminate; a second ply comprising a third surface adjacent the second surface and a fourth surface opposite the third surface, wherein the fourth surface comprises an inner surface of the laminate; and an interlayer positioned between the first ply and the second ply, wherein at least one of the first ply or second ply is formed from a glass comprising 64 weight percent to 75 weight percent SiO₂, or even 68 weight percent to 75 weight percent SiO₂; 10 weight percent to 20 weight percent Na₂O, or even 10 weight percent to 18 weight percent Na₂O; 5 weight percent to 15 weight percent CaO; 0 weight percent to 10 weight percent MgO; 0 weight percent to 5 weight percent Al₂O₃; 0 weight percent to 5 weight percent K₂O; 0 weight percent to 1 weight percent SO₃, or even 0.05 weight percent to 0.3 weight percent SO₃; and 1 weight percent to 3.5 weight percent total iron, preferably 1.25 weight percent to 3 weight percent total iron, or even more preferably 1.5 weight percent to 2.5 weight percent total iron, wherein the glass has a visible light transmission (T_{LA}) in the range of equal to or greater than 6 percent and equal to or less than 25 percent, or even equal to or greater than 7 percent and equal to or less than 24 percent, or even equal to or greater than 8 percent and equal to or less than 23 percent, or even equal to or greater than 9 percent and equal to or less than 22 percent, at a glass thickness of 3.85 mm via T_{LA} CIE Illuminant A across wavelengths 380 nm to 780 nm, an a* in the range of −4 to 0, or an a* in the range of −3.5 to −0.25, or an a* in the range of −3 to −0.5, or even an a* in the range of −2.5 to −0.75, and a b* in the range of −1 to 7, or a b* in the range of −0.5 to 6.5, or a b* in the range of 0 to 6, or even a b* in the range of 0.5 to 5.5.

Clause 42: The laminate of clause 41, wherein the glass comprises a redox ratio in the range of 0.1 to 0.3.

Clause 43: The laminate of any of clauses 41 or 42, wherein the glass comprises a redox ratio in the range of 0.13 to 0.28, or even in the range of 0.18 to 0.22.

Clause 44: The laminate of any of clauses 41 to 43, wherein the glass has an ultraviolet transmittance (T_{UV}) of equal to or less than 10 percent, of equal to or less than 9 percent, of equal to or less than 8 percent, of equal to or less than 7 percent, or even of equal to or less than 6 percent at a glass thickness of 3.85 mm at a wavelength range of 300 nm to 400 nm using the ISO 13837 standard.

Clause 45: The laminate of any of clauses 41 to 44, wherein the glass has a direct solar energy transmission (T_{DS}) of equal to or less than 20 percent, equal to or less than 18 percent, equal to or less than 16 percent, or even equal to or less than 13 percent in the range of 300 to 2500 nm with intervals of 5, 10 and 50 nm, according to the ISO 13837 standard. In another embodiment, the glass of any of clauses 41 to 44 has a T_{DS} in the range of 5 percent to 20 percent, or in the range of 6 percent to 18 percent, or even in the range of 7 percent to 15 percent in the range of 300 to 2500 nm with intervals of 5, 10 and 50 nm, according to the ISO 13837 standard.

Clause 46: The laminate of any of clauses 41 to 45, wherein the glass has an infrared transmittance (T_{IR}) of equal to or less than 18 percent, equal to or less than 16 percent, equal to or less than 15 percent, equal to or less than 13 percent, equal to or less than 12 percent, equal to or less than 11 percent, or even equal to or less than 10 percent, when measured over the wavelength range of 800 nm to 2500 nm using the ISO 13837 standard.

Clause 47: The laminate of any of clauses 41 to 46, wherein the glass has a total solar energy transmittance (T_{TS}) of equal to or less than 50 percent, of equal to or less than 45 percent, of equal to or less than 40 percent, of equal to or less than 35 percent, of equal to or less than 30 percent, of equal to or less than 25 percent, or even of equal to or less than 20 percent at a glass thickness of 3.85 mm, when measured using the ISO 13837 standard.

Clause 48: The laminate of any of clauses 41 to 47, wherein the glass has a dominant wavelength of 490 nm to 570 nm when it has a nominal thickness of 3.85 mm and is manufactured by a float process.

Clause 49: The laminate of any of clauses 41 to 48, wherein the glass has a purity in the range of 0.4 percent to 12 percent, or in the range of 0.6 percent to 11 percent, or in the range of 0.8 percent to 10 percent, or even in the range of 1 percent to 9 percent.

Clause 50: The laminate of any of clauses 41 to 49, wherein the glass further comprises 0.02 weight percent to 0.04 weight percent Co₃O₄, or from 0.021 weight percent to 0.039 weight percent Co₃O₄, or even from 0.022 weight percent to 0.038 weight percent Co₃O₄.

Clause 51: The laminate of any of clauses 41 to 50, wherein the glass further comprises 0.0001 weight percent to 0.02 weight percent CuO, or from 0.005 weight percent to 0.01 weight percent CuO, or even from 0.001 weight percent to 0.008 weight percent CuO.

Clause 52: The laminate of any of clauses 41 to 51, wherein the glass further comprises 0.002 weight percent to 0.005 weight percent selenium (Se), or from 0.0022 weight percent to 0.0045 weight percent selenium, or from 0.0024 weight percent to 0.004 weight percent selenium, or even from 0.0026 weight percent to 0.0035 weight percent selenium.

Clause 53: The laminate of any of clauses 41 to 52, wherein the glass further comprises 0.01 weight percent to 0.15 weight percent TiO₂, or from 0.02 weight percent to 0.1 weight percent TiO₂, or even from 0.03 weight percent to 0.09 weight percent TiO₂.

Clause 54: The laminate of any of clauses 41 to 53, wherein the glass further comprises 0.25 weight percent to 0.5 weight percent FeO, or from 0.3 weight percent to 0.45 weight percent FeO, or even from 0.35 weight percent to 0.49 weight percent FeO.

Clause 55: The laminate of any of clauses 41 to 54, wherein the glass further comprises 0.1 weight percent to 0.25 weight percent SO₃, or from 0.12 weight percent to 0.23 weight percent SO₃, or even from 0.14 weight percent to 0.21 weight percent SO₃.

Clause 56: The laminate of any of clauses 41 to 55, wherein the glass further comprises 0.1 weight percent to 0.7 weight percent sodium nitrate (NaNO₃), or from 0.25 weight percent to 0.65 weight percent NaNO₃, or even from 0.35 weight percent to 0.55 weight percent NaNO₃.

Clause 57: The laminate of any of clauses 41 to 56, wherein the glass further comprises either no added coal or other carbon source (that is zero weight percent), or from 0.01 weight percent to 0.04 weight percent coal or other carbon source, or from 0.015 weight percent to 0.035 weight percent coal or other carbon source, or even from 0.02 weight percent to 0.03 weight percent coal or other carbon source.

Clause 58: The laminate of any of clauses 41 to 57, wherein the glass further comprises 0.0005 weight percent (5 ppm) to 0.01 weight percent (100 ppm) Cr₂O₃, or from 0.001 weight percent (10 ppm) to 0.009 weight percent (90 ppm) Cr₂O₃, 0.002 weight percent (20 ppm) to 0.008 weight percent (80 ppm) Cr₂O₃, or even from 0.003 weight percent (30 ppm) to 0.007 weight percent (70 ppm) Cr₂O₃.

Clause 59: The laminate of any of clauses 41 to 58, wherein the glass has a gray color as determined by the naked eye.

Clause 60: The laminate of any of clauses 41 to 59, wherein the glass is used in one or more of an architectural transparency or a vehicle transparency; or wherein the glass is used in one or more of an architectural transparency or a vehicle transparency, and wherein the architectural transparency or the vehicle transparency comprises one or more low-e coatings, one or more anti-reflective coatings, one or more solar control coatings, one or more low UV and/or IRC coatings, or combinations of any two or more thereof.

Clause 61: A method of reducing visible light transmittance in a glass sheet comprising the steps of melting a glass batch to provide a pool of molten glass and cooling the molten glass batch to yield a molten glass, wherein the glass comprises 64 weight percent to 75 weight percent SiO₂, or even 68 weight percent to 75 weight percent SiO₂; 10 weight percent to 20 weight percent Na₂O, or even 10 weight percent to 18 weight percent Na₂O; 5 weight percent to 15 weight percent CaO; 0 weight percent to 10 weight percent MgO; 0 weight percent to 5 weight percent Al₂O₃; 0 weight percent to 5 weight percent K₂O; 0 weight percent to 1 weight percent SO₃, or even 0.05 weight percent to 0.3 weight percent SO₃; and 1 weight percent to 3.5 weight percent total iron, preferably 1.25 weight percent to 3 weight percent total iron, or even more preferably 1.5 weight percent to 2.5 weight percent total iron, wherein the glass has a visible light transmission (T_{LA}) in the range of equal to or greater than 6 percent and equal to or less than 25 percent, or even equal to or greater than 7 percent and equal to or less than 24 percent, or even equal to or greater than 8 percent and equal to or less than 23 percent, or even equal to or greater than 9 percent and equal to or less than 22 percent, at a glass thickness of 3.85 mm via T_{L}A CIE Illuminant A across wavelengths 380 nm to 780 nm, an a* in the range of −4 to 0, or an a* in the range of −3.5 to −0.25, or an a* in the range of −3 to −0.5, or even an a* in the range of −2.5 to −0.75, and a b* in the range of −1 to 7, or a b* in the range of −0.5 to 6.5, or a b* in the range of 0 to 6, or even a b* in the range of 0.5 to 5.5.

Clause 62: The method of clause 61, wherein the glass comprises a redox ratio in the range of 0.1 to 0.3.

Clause 63: The method of any of clauses 61 or 62, wherein the glass comprises a redox ratio in the range of 0.13 to 0.28, or even in the range of 0.18 to 0.22.

Clause 64: The method of any of clauses 61 to 63, wherein the glass has an ultraviolet transmittance (T_{UV}) of equal to or less than 10 percent, of equal to or less than 9 percent, of equal to or less than 8 percent, of equal to or less than 7 percent, or even of equal to or less than 6 percent at a glass thickness of 3.85 mm at a wavelength range of 300 nm to 400 nm using the ISO 13837 standard.

Clause 65: The method of any of clauses 61 to 64, wherein the glass has a direct solar energy transmission (T_{DS}) of equal to or less than 20 percent, equal to or less than 18 percent, equal to or less than 16 percent, or even equal to or less than 13 percent in the range of 300 to 2500 nm with intervals of 5, 10 and 50 nm, according to the ISO 13837 standard. In another embodiment, the glass of any of clauses 61 to 64 has a T_{DS} in the range of 5 percent to 20 percent, or in the range of 6 percent to 18 percent, or even in the range of 7 percent to 15 percent in the range of 300 to 2500 nm with intervals of 5, 10 and 50 nm, according to the ISO 13837 standard.

Clause 66: The method of any of clauses 61 to 65, wherein the glass has an infrared transmittance (T_{IR}) of equal to or less than 18 percent, equal to or less than 16 percent, equal to or less than 15 percent, equal to or less than 13 percent, equal to or less than 12 percent, equal to or less than 11 percent, or even equal to or less than 10 percent, when measured over the wavelength range of 800 nm to 2500 nm using the ISO 13837 standard.

Clause 67: The method of any of clauses 61 to 66, wherein the glass has a total solar energy transmittance (T_{TS}) of equal to or less than 50 percent, of equal to or less than 45 percent, of equal to or less than 40 percent, of equal to or less than 35 percent, of equal to or less than 30 percent, of equal to or less than 25 percent, or even of equal to or less than 20 percent at a glass thickness of 3.85 mm, when measured using the ISO 13837 standard.

Clause 68: The method of any of clauses 61 to 67, wherein the glass has a dominant wavelength of 490 nm to 570 nm when it has a nominal thickness of 3.85 mm and is manufactured by a float process.

Clause 69: The method of any of clauses 61 to 68, wherein the glass has a purity in the range of 0.4 percent to 12 percent, or in the range of 0.6 percent to 11 percent, or in the range of 0.8 percent to 10 percent, or even in the range of 1 percent to 9 percent.

Clause 70: The method of any of clauses 61 to 69, wherein the glass further comprises 0.02 weight percent to 0.04 weight percent Co₃O₄, or from 0.021 weight percent to 0.039 weight percent Co₃O₄, or even from 0.022 weight percent to 0.038 weight percent Co₃O₄.

Clause 71: The method of any of clauses 61 to 70, wherein the glass further comprises 0.0001 weight percent to 0.02 weight percent CuO, or from 0.005 weight percent to 0.01 weight percent CuO, or even from 0.001 weight percent to 0.008 weight percent CuO.

Clause 72: The method of any of clauses 61 to 71, wherein the glass further comprises 0.002 weight percent to 0.005 weight percent selenium (Se), or from 0.0022 weight percent to 0.0045 weight percent selenium, or from 0.0024 weight percent to 0.004 weight percent selenium, or even from 0.0026 weight percent to 0.0035 weight percent selenium.

Clause 73: The method of any of clauses 61 to 72, wherein the glass further comprises 0.01 weight percent to 0.15 weight percent TiO₂, or from 0.02 weight percent to 0.1 weight percent TiO₂, or even from 0.03 weight percent to 0.09 weight percent TiO₂.

Clause 74: The method of any of clauses 61 to 73, wherein the glass further comprises 0.25 weight percent to 0.5 weight percent FeO, or from 0.3 weight percent to 0.45 weight percent FeO, or even from 0.35 weight percent to 0.49 weight percent FeO.

Clause 75: The method of any of clauses 61 to 74, wherein the glass further comprises 0.1 weight percent to 0.25 weight percent SO₃, or from 0.12 weight percent to 0.23 weight percent SO₃, or even from 0.14 weight percent to 0.21 weight percent SO₃.

Clause 76: The method of any of clauses 61 to 75, wherein the glass further comprises 0.1 weight percent to 0.7 weight percent sodium nitrate (NaNO₃), or from 0.25 weight percent to 0.65 weight percent NaNO₃, or even from 0.35 weight percent to 0.55 weight percent NaNO₃.

Clause 77: The method of any of clauses 61 to 76, wherein the glass further comprises either no added coal or other carbon source (that is zero weight percent), or from 0.01 weight percent to 0.04 weight percent coal or other carbon source, or from 0.015 weight percent to 0.035 weight percent coal or other carbon source, or even from 0.02 weight percent to 0.03 weight percent coal or other carbon source.

Clause 78: The method of any of clauses 61 to 77, wherein the glass further comprises 0.0005 weight percent (5 ppm) to 0.01 weight percent (100 ppm) Cr₂O₃, or from 0.001 weight percent (10 ppm) to 0.009 weight percent (90 ppm) Cr₂O₃, 0.002 weight percent (20 ppm) to 0.008 weight percent (80 ppm) Cr₂O₃, or even from 0.003 weight percent (30 ppm) to 0.007 weight percent (70 ppm) Cr₂O₃.

Clause 79: The method of any of clauses 61 to 78, wherein the glass has a gray color as determined by the naked eye.

Clause 80: The method of any of clauses 61 to 79, wherein the glass is used in one or more of an architectural transparency or a vehicle transparency; or wherein the glass is used in one or more of an architectural transparency or a vehicle transparency, and wherein the architectural transparency or the vehicle transparency comprises one or more low-e coatings, one or more anti-reflective coatings, one or more solar control coatings, one or more low UV and/or IRC coatings, or combinations of any two or more thereof.

Clause 81: The glass of any of clauses 1-80, wherein the glass has an ultraviolet transmittance (T_{UV}) in the range of equal to or greater than 1 percent and equal to or less than 6 percent, or alternatively equal to or greater than 1 percent and equal to or less than 10 percent.

Clause 82: The glass of any of clauses 1-81, wherein the glass has a visible light transmission (T_{LA}) in the range of equal to or greater than 8 percent and equal to or less than 15 percent, or alternatively equal to or greater than 8 percent and equal to or less than 22 percent.

Clause 83: The glass of any of clauses 1-82, wherein the glass has a direct solar energy transmission (T_{DS}) in the range of equal to or greater than 7 percent and equal to or less than 13, or alternatively equal to or greater than 7 percent and equal to or less than 20 percent.

Clause 84: The glass of any of clauses 1-83, wherein the glass has an infrared transmittance (T_{IR}) in the range of equal to or greater than 7 percent and equal to or less than 13, or alternatively equal to or greater than 7 percent and equal to or less than 18 percent.

Clause 85: The glass of any of clauses 1-84, wherein the glass has an infrared transmittance (T_{IR}) of equal to or less than 50 percent, or alternatively equal to or less than 35 percent, or alternatively in the range of equal to or greater than 30 percent and equal to or less than 50, or alternatively equal to or greater than 30 percent and equal to or less than 35 percent.

Clause 86: The glass of any of clauses 1-85, wherein the glass has an L* in the range of 35 to 45, or an L* in the range of 36 to 44, or an L* in the range of 37 to 43, or an L* in the range of 38 to 42, or even an L* in the range of 39 to 41, or alternatively an L* in the range of 35 to 55, or an L* in the range of 36 to 54, or an L* in the range of 37 to 53, or an L* in the range of 38 to 52, or an L* in the range of 39 to 51, or an L* in the range of 40 to 50, or an L* in the range of 41 to 49, or an L* in the range of 42 to 48, or an L* in the range of 43 to 47, or even an L* in the range of 44 to 46.

### DETAILED DESCRIPTION OF THE INVENTION

Unless otherwise indicated, all numbers expressing dimensions, physical characteristics, quantities of ingredients, reaction conditions, and so forth used in the specification and claims include the beginning and ending range values, and to encompass any and all subranges subsumed therein. For example, a stated range of “1 to 10” should be considered to include any and all subranges between (and inclusive of) the minimum value of 1 and the maximum value of 10.

Any reference to composition amounts, unless otherwise specified, is “by weight percent” based on the total weight of the final glass composition. The “total iron” content of the glass compositions disclosed herein is expressed in terms of Fe₂O₃ in accordance with standard analytical practice, regardless of the form actually present. Likewise, the amount of iron in the ferrous state is reported as FeO, even though it may not actually be present in the glass as FeO. The terms “redox”, “redox ratio”, or “iron redox ratio” mean the amount of iron in the ferrous state (expressed as FeO) divided by the amount of total iron (expressed as Fe₂O₃). The “sulfur” content of the glass compositions disclosed herein is expressed in terms of SO₃ in accordance with standard analytical practices, regardless of the form actually present.

As used herein, “visible transmittance” values are determined using the conventional CIE Illuminant A and a 2-degree observer angle. Those skilled in the art will understand that properties such as visible transmittance can be calculated at an equivalent standard thickness, e.g., 3.85 millimeters (mm), even though the actual thickness of a measured glass sample is different than the standard thickness.

All documents, such as, but not limited to, issued patents and patent applications, referred to herein are to be considered to be incorporated by reference in their entireties.

As can be read from the above, iron is present in glass (silica-sodium-calcium) in two compounds that depend on the oxidation state of the iron: if the iron is present as Fe²⁺, the compound formed is ferrous oxide (FeO). If iron is present as Fe³⁺, ferric oxide (Fe₂O₃) would be present. Each ion confers different properties; the ferrous ion has a wide and strong absorption band centered at 1050 nm, which results in a decrease in infrared radiation. Furthermore, this band extends into the visible region, decreasing light transmission and imparting a bluish coloration to the glass. On the other hand, the ferric ion features a strong absorption band located in the ultraviolet region, which evidently prevents its transmission through the glass and, in addition, it shows two other weak bands in the visible region located between 420 and 440 nm, which cause a slight decrease in light transmission and a yellowing of the glass.

Generally, the iron in glass and its amount of ferrous oxide are expressed in the form of Fe₂O₃. It is common in the industry to express the amount of ferrous or ferric oxide as a percentage of total iron. The balance between ferrous and ferric oxide has a direct effect on the color and transmittance characteristics of the glass, represented as:

$$Iron Redox Ratio = \frac{{Fe}^{2 +} ( as weight percent FeO )}{Total Fe ( as weight percent {Fe}_{2} {O}_{3} )}$$

The term “iron redox ratio” means the amount of iron in the ferrous state (expressed as FeO) divided by the amount of total iron (expressed as Fe₂O₃). This means that the greater the amount of ferric ion (Fe³⁺) presented in the glass, the greater the absorption of ultraviolet radiation and the transmission of light will increase; as well as the yellowish hue; but, if the content of the ferrous ion (Fe²⁺) increases as a result of the chemical reduction of Fe₂O₃, the absorption of the infrared radiation will increase, but the ultraviolet radiation will decrease as well as the light transmission.

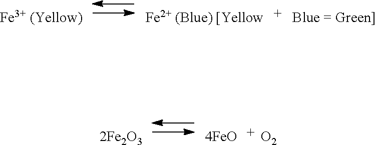

The variation of the concentration of FeO in relation to Fe₂O₃, gives rise to a change of color in the glass. The displacement of the color can be modified from yellow through green and blue until reaching amber. From blue, the amber coloration in the glass is given by the formation of iron polysulfide under high redox conditions. The color changes in the following way (according to experimental results):
Yellow—Low redox (0.12)—High light transmission (High ferric ion)
Yellow—Green (0.16)
Green—Yellowish (0.20)
Green—(0.25)—Typical green glass value
Bluish Green—(0.29)
Greenish Blue—(0.35)
Blue—(0.50)
Olive Green—(0.60)
Champagne—(0.65)
Amber—High redox (0.75)—Low light transmission (low ferric ion)

As will be appreciated by one of ordinary skill in the art, controlling redox of a glass composition is achieved by controlling the conditions under which the glass is made. Many such factors may affect redox. The concentration of reducing agents (such as carbon) and the concentration of oxidizing agents (such as sodium sulfate) may each affect redox. For example, sodium sulfate (Na₂SO₄) may be added as a raw material to the glass batch for bubble elimination, high temperature refinement, promotion of mass transport, dissolution of free silica at the surface of the glass and lessening the number of solid inclusions. However, Na₂SO₄ has oxidizing properties, such that small amounts of carbon are usually added to the mixture in order to counteract undesired oxidation. Further, Na₂SO₄ is converted during the glass manufacturing process into SO₃, which has an inverse relationship with redox, while sulfur has as direct relationship with redox. Finally, melting conditions, such as varying oxygen excess and adjusting flame alignment during combustion in a furnace, may further affect redox.

To control the balance between ferrous oxide and ferric oxide necessary to achieve solar control glass, it is necessary to establish the mixing and melting atmosphere conditions; for the former case, the concentration of reducing agents such as carbon and oxidizing agents, such as sodium sulfate and sodium nitrate, is adjusted. Regarding fusion conditions, it is necessary to adjust the atmosphere with greater or lesser oxygen content depending on the thermal performance and shade of the desired glass.

Additionally, titanium oxide also acts as a dye and when used in combination with Fe₂O₃, it is possible to obtain a further reduction of the transmission of ultraviolet radiation to a point where the desired visibility transmission is achieved.

In one aspect of the present invention, the present invention comprises a glass that comprises 64 weight percent to 75 weight percent SiO₂, or even 68 weight percent to 75 weight percent SiO₂; 10 weight percent to 20 weight percent Na₂O, or even 10 weight percent to 18 weight percent Na₂O; 5 weight percent to 15 weight percent CaO; 0 weight percent to 10 weight percent MgO; 0 weight percent to 5 weight percent Al₂O₃; 0 weight percent to 5 weight percent K₂O; 0 weight percent to 1 weight percent SO₃, or even 0.05 weight percent to 0.3 weight percent SO₃; and 1 weight percent to 3.5 weight percent total iron, preferably 1.25 weight percent to 3 weight percent total iron, or even more preferably 1.5 weight percent to 2.5 weight percent total iron, wherein the glass has a visible light transmission (T_{LA}) in the range of equal to or greater than 6 percent and equal to or less than 25 percent, or even equal to or greater than 7 percent and equal to or less than 24 percent, or even equal to or greater than 8 percent and equal to or less than 23 percent, or even equal to or greater than 9 percent and equal to or less than 22 percent, at a glass thickness of 3.85 mm via T_{LA} CIE Illuminant A across wavelengths 380 nm to 780 nm, an a* in the range of −4 to 0, or an a* in the range of −3.5 to −0.25, or an a* in the range of −3 to −0.5, or even an a* in the range of −2.5 to −0.75, and a b* in the range of −1 to 7, or a b* in the range of −0.5 to 6.5, or a b* in the range of 0 to 6, or even a b* in the range of 0.5 to 5.5. Here, as well as elsewhere in the specification, Examples, and claims, any one or more individual numerical values can be combined to form additional, or even new/non-disclosed, numerical ranges.

With regard to the weight percentages of various compounds added to the glass compositions disclosed herein, such additives are based on weight percentages which can alternatively be viewed as any stated weight percent of any desired additive where such weight percent is based on 100 parts by weight of a base glass composition.

According to the present invention, the following performance properties are measured as described below. The ultraviolet transmittance (T_{UV}) is measured over the wavelength range of 300 nm to 400 nm, using the ISO 13837 standard. Additionally, if applicable, the visible light transmittance (T_{LA}) is measured using CIE standard illuminant A (also referred to herein as just CIE Illuminant A) over the wavelength range 380 nm to 780 nm; the infrared transmittance (T_{IR}) is measured over the wavelength range of 800 nm to 2500 nm, using the ISO 13837 standard; and the total solar energy transmittance (T_{TS}) is measured using the ISO 13837 standard. If applicable, the T_{UV}, T_{IR}, and T_{TS} transmittance data is calculated using Parry Moon air mass 1.5 direct solar irradiance data and integrated using the Trapezoidal Rule, as is known in the art. Furthermore, the direct solar energy transmission (T_{DS}) of the glasses of the present invention are determined in the range of 300 to 2500 nm with intervals of 5, 10 and 50 nm, according to the ISO 13837 standard.

Additionally, one or more of the color variables L*, a*, and b* of the color system CIELAB 1976 are also calculated through the tristimulus values.

The glass may be melted and refined in a continuous, large-scale commercial glass melting operation. It may further be formed into flat glass sheets of varying thickness by the float method in which the molten glass is supported on a pool of molten metal, usually tin, as it assumes a ribbon shape and is cooled in a manner well known in the art.

It should be noted that in any of the methods disclosed herein, coal can be utilized in the batch chemistry for forming the various glasses disclosed herein. In another instance, the coal in the batch chemistry can be replaced at a one to one ratio with any other suitable alternative source of carbon including, but not limited to, graphite. Should this change be made, no other changes need to be made to the batch chemistry in any of the above embodiments. Additionally, should an electric furnace be used to process the batch chemistry, the amount of coal, or other carbon source, should be varied accordingly in light of the different processing environment present in an electric furnace to that of a gas furnace. In one non-limiting example, since the coal, or other carbon source, is considered a reducing agent, the amount of carbon used should be varied based on the nature of the atmospheric makeup and/or environment present in the furnace used to process a desired glass batch in accordance with any of the embodiments of the invention.

As is known in the art, glass recycling is an integral part of various types of glass production. As such, in some cases the present invention may make use of one or more sources of glass cullet (i.e., recycled glass material). As is known, there are two types of cullet—internal and external. Internal cullet is composed of defective products detected and rejected by a quality control process during the industrial process of glass manufacturing, transition phases of product changes (such as thickness and color changes) and production offcuts, while external cullet is waste glass that has been collected or reprocessed with the purpose of recycling. External cullet, which can be pre- or post-consumer, may be classified as waste. In some embodiments, the present invention can make use of any suitable type of cullet, be it internal or external cullet.

As would be appreciated, the present invention is not limited to just a glass composition but rather to a glass composition that can be used to form various glass-containing items where one or more layers of a glass according to any of the embodiments disclosed herein are desirable. Such glass-containing items can include, but are not limited to, display screens, architectural, transparencies, vehicle transparencies, etc.

In another instance, the glass composition of the present invention can be used to form a transparency that can be used in any desired architectural or vehicle application be such transparency a monolithic (i.e., one layer) structure, a multilayered structure, or even a multilayered laminated structure (e.g., a laminated vehicle transparency). It should be noted that any suitable layered, or even non-layered, structure can be formed so as to contain at least one glass layer of the present invention. Since such structures are known to those of skill in the art, a detailed discussion herein is omitted for the sake of brevity.

In still another embodiment, the glass of the present invention can be coated with any one or more coatings known to those of skill in the art. Such coatings include, but are not limited to, one or more low-e coatings, one or more anti-reflective coatings, one or more solar control coatings (such as that have the ability to modify the amount of transmitted, reflected and absorbed solar radiation in the solar range comprised between 300 and 2500 nm), one or more low UV and/or IRC (near-IR) coatings, or combinations of any two or more thereof. Some non-limiting examples of suitable coatings are contained in U.S. Pat. No. 11,479,502 and WO 2014/058290, the disclosures of which are hereby incorporated by reference in their entireties.

In one embodiment, the present invention is directed to a gray glass composition that, although its use in the automotive industry is mentioned as its main application, said use is not limited to other fields such as the construction industry or other applications such as, for example, as a substrate to be coated by one or more thin layers applied via cathodic vacuum erosion process (MSVD), chemical vapor deposition (CVD) or other techniques.

The typical composition of a silica-sodium-calcium glass formed by the float glass process for the automotive industry is characterized by the following formulation based on the percentage by weight with respect to the total weight of the glass:

| Components | Weight Percent: |
|---|---|
| SiO₂ | 64 to 75, or even 68 to 75; |
| Na₂O | 10 to 20, or even 10 to 18; |
| CaO | 5 to 15; |
| MgO | 0 to 10; |
| Al₂O₃ | 0 to 5; |
| K₂O | 0 to 5; and |
| SO₃ | 0 to 1, or even 0.05 to 0.3. |

The glass composition of the present invention is based on a silica-sodium-calcium glass to which the following dyes were added in order to obtain a gray color:

| Components | Weight Percent: |
|---|---|
| Total Iron | 1 to 3.5; |
| Fe₂O₃ | 1.25 to 3; |
| FeO | 0.25 to 0.5; |
| Redox | 0.1 to 0.3; |
| Co₃O₄ | 0.02 to 0.04; |
| CuO | 0.0001 to 0.02; |
| Se | 0.002 to 0.005; |
| TiO₂ | 0.01 to 0.15; |
| SO₃ | 0.1 to 0.25; |
| NaNO₃ | 0.1 to 0.7; |
| Coal/Carbon | 0 to 0.04, or even 0.01 |
| Cr₂O₃ | to 0.04; and 0.0001 to 0.01. |

The main purpose of adding sodium nitrate (NaNO₃) and carbon to the composition is to modify the oxidation state of iron so as to achieve the optimal level of direct heat transfer (T_{DS}). Also, sodium nitrate helps optimizing retention of selenium in the glass.

In one embodiment, the gray glass of the present invention has a visible light transmission (T_{LA}) in the range of equal to or greater than 6 percent and equal to or less than 25 percent, or even equal to or greater than 7 percent and equal to or less than 24 percent, or even equal to or greater than 8 percent and equal to or less than 23 percent, or even equal to or greater than 9 percent and equal to or less than 22 percent, at a glass thickness of 3.85 mm via T_{LA} CIE Illuminant A across wavelengths 380 nm to 780 nm, an a* in the range of −4 to 0, or an a* in the range of −3.5 to −0.25, or an a* in the range of −3 to −0.5, or even an a* in the range of −2.5 to −0.75, and a b* in the range of −1 to 7, or a b* in the range of −0.5 to 6.5, or a b* in the range of 0 to 6, or even a b* in the range of 0.5 to 5.5. Here, as well as elsewhere in the specification, Examples, and claims, any one or more individual numerical values can be combined to form additional, or even new/non-disclosed, numerical ranges.

In another embodiment, the gray glass of the present invention has as an ultraviolet transmittance (T_{UV}) of equal to or less than 10 percent, of equal to or less than 9 percent, of equal to or less than 8 percent, of equal to or less than 7 percent, or even of equal to or less than 6 percent at a glass thickness of 3.85 mm at a wavelength range of 300 nm to 400 nm using the ISO 13837 standard.

In still another embodiment, the gray glass of the present invention has as a direct solar energy transmission (T_{DS}) of equal to or less than 20 percent, equal to or less than 18 percent, equal to or less than 16 percent, or even equal to or less than 13 percent in the range of 300 to 2500 nm with intervals of 5, 10 and 50 nm, according to the ISO 13837 standard. In another embodiment, the gray glass of the present invention has a T_{DS} in the range of 5 percent to 20 percent, or in the range of 6 percent to 18 percent, or even in the range of 7 percent to 15 percent in the range of 300 to 2500 nm with intervals of 5, 10 and 50 nm, according to the ISO 13837 standard.

In still another embodiment, the gray glass of the present invention has as an infrared transmittance (T_{IR}) of equal to or less than 18 percent, equal to or less than 16 percent, equal to or less than 15 percent, equal to or less than 13 percent, equal to or less than 12 percent, equal to or less than 11 percent, or even equal to or less than 10 percent, when measured over the wavelength range of 800 nm to 2500 nm using the ISO 13837 standard. In still another embodiment, the gray glass of the present invention has as a total solar energy transmittance (T_{TS}) of equal to or less than 50 percent, of equal to or less than 45 percent, of equal to or less than 40 percent, of equal to or less than 35 percent, of equal to or less than 30 percent, of equal to or less than 25 percent, or even of equal to or less than 20 percent at a glass thickness of 3.85 mm, when measured using the ISO 13837 standard.

In still another embodiment, the gray glass of the present invention has as a dominant wavelength of 490 nm to 570 nm when it has a nominal thickness of 3.85 mm and is manufactured by a float process. In still another embodiment, the gray glass of the present invention has as a purity in the range of 0.4 percent to 12 percent, or in the range of 0.6 percent to 11 percent, or in the range of 0.8 percent to 10 percent, or even in the range of 1 percent to 9 percent.

While the above properties of the glass of the present invention are stated for a thickness of 3.85 mm, such property values listed herein also apply for glass having a thickness of between 1.4 mm to 6 mm, or even from 1.6 mm to 5 mm, and more preferably, as is noted above, 3.85 mm. In still another embodiment, the glass of the present invention avoids the use of coloring compounds such as nickel, manganese, or even rare earth oxides including, but not limited to, erbium oxide (Er₂O₃).

Accordingly, in light of the above, in one embodiment of the invention, a glass comprises 64 weight percent to 75 weight percent SiO₂, or even 68 weight percent to 75 weight percent SiO₂; 10 weight percent to 20 weight percent Na₂O, or even 10 weight percent to 18 weight percent Na₂O; 5 weight percent to 15 weight percent CaO; 0 weight percent to 10 weight percent MgO; 0 weight percent to 5 weight percent Al₂O₃; 0 weight percent to 5 weight percent K₂O; 0 weight percent to 1 weight percent SO₃, or even 0.05 weight percent to 0.3 weight percent SO₃; and 1 weight percent to 3.5 weight percent total iron, preferably 1.25 weight percent to 3 weight percent total iron, or even more preferably 1.5 weight percent to 2.5 weight percent total iron, wherein the glass has a visible light transmission (T_{LA}) in the range of equal to or greater than 6 percent and equal to or less than 25 percent, or even equal to or greater than 7 percent and equal to or less than 24 percent, or even equal to or greater than 8 percent and equal to or less than 23 percent, or even equal to or greater than 9 percent and equal to or less than 22 percent, at a glass thickness of 3.85 mm via T_{L}A CIE Illuminant A across wavelengths 380 nm to 780 nm, an a* in the range of −4 to 0, or an a* in the range of −3.5 to −0.25, or an a* in the range of −3 to −0.5, or even an a* in the range of −2.5 to −0.75, and a b* in the range of −1 to 7, or a b* in the range of −0.5 to 6.5, or a b* in the range of 0 to 6, or even a b* in the range of 0.5 to 5.5. Here, as well as elsewhere in the specification, Examples, and claims, any one or more individual numerical values can be combined to form additional, or even new/non-disclosed, numerical ranges.

In another embodiment, the glass of the present invention comprises a redox ratio in the range of 0.1 to 0.3. In still another embodiment, the glass of the present invention comprises a redox ratio in the range of 0.13 to 0.28, or even in the range of 0.18 to 0.22.

In still another embodiment, the glass of the present invention has an ultraviolet transmittance (T_{UV}) of equal to or less than 10 percent, of equal to or less than 9 percent, of equal to or less than 8 percent, of equal to or less than 7 percent, or even of equal to or less than 6 percent at a glass thickness of 3.85 mm at a wavelength range of 300 nm to 400 nm using the ISO 13837 standard. In still another embodiment, the glass of the present invention has a direct solar energy transmission (T_{DS}) of equal to or less than 20 percent, equal to or less than 18 percent, equal to or less than 16 percent, or even equal to or less than 13 percent in the range of 300 to 2500 nm with intervals of 5, 10 and 50 nm, according to the ISO 13837 standard. In another embodiment, the gray glass of the present invention has a T_{DS} in the range of 5 percent to 20 percent, or in the range of 6 percent to 18 percent, or even in the range of 7 percent to 15 percent in the range of 300 to 2500 nm with intervals of 5, 10 and 50 nm, according to the ISO 13837 standard.

In still another embodiment, the glass of the present invention has an infrared transmittance (T_{IR}) of equal to or less than 18 percent, equal to or less than 16 percent, equal to or less than 15 percent, equal to or less than 13 percent, equal to or less than 12 percent, equal to or less than 11 percent, or even equal to or less than 10 percent, when measured over the wavelength range of 800 nm to 2500 nm using the ISO 13837 standard. In still another embodiment, the glass of the present invention has a total solar energy transmittance (T_{TS}) of equal to or less than 50 percent, of equal to or less than 45 percent, of equal to or less than 40 percent, of equal to or less than 35 percent, of equal to or less than 30 percent, of equal to or less than 25 percent, or even of equal to or less than 20 percent at a glass thickness of 3.85 mm, when measured using the ISO 13837 standard. In still another embodiment, the glass of the present invention has a dominant wavelength of 490 nm to 570 nm when it has a nominal thickness of 3.85 mm and is manufactured by a float process. In still another embodiment, the glass of the present invention has a purity in the range of 0.4 percent to 12 percent, or in the range of 0.6 percent to 11 percent, or in the range of 0.8 percent to 10 percent, or even in the range of 1 percent to 9 percent.

In still another embodiment, the glass of the present invention comprises 0.02 weight percent to 0.04 weight percent Co₃O₄, or from 0.021 weight percent to 0.039 weight percent Co₃O₄, or even from 0.022 weight percent to 0.038 weight percent Co₃O₄. In still another embodiment, the glass of the present invention comprises 0.0001 weight percent to 0.02 weight percent CuO, or from 0.005 weight percent to 0.01 weight percent CuO, or even from 0.001 weight percent to 0.008 weight percent CuO. In still another embodiment, the glass of the present invention comprises 0.002 weight percent to 0.005 weight percent selenium (Se), or from 0.0022 weight percent to 0.0045 weight percent selenium, or from 0.0024 weight percent to 0.004 weight percent selenium, or even from 0.0026 weight percent to 0.0035 weight percent selenium.

In still another embodiment, the glass of the present invention comprises 0.01 weight percent to 0.15 weight percent TiO₂, or from 0.02 weight percent to 0.1 weight percent TiO₂, or even from 0.03 weight percent to 0.09 weight percent TiO₂. In still another embodiment, the glass of the present invention comprises 0.25 weight percent to 0.5 weight percent FeO, or from 0.3 weight percent to 0.45 weight percent FeO, or even from 0.35 weight percent to 0.49 weight percent FeO. In still another embodiment, the glass of the present invention comprises 0.1 weight percent to 0.25 weight percent SO₃, or from 0.12 weight percent to 0.23 weight percent SO₃, or even from 0.14 weight percent to 0.21 weight percent SO₃. In still another embodiment, the glass of the present invention comprises 0.1 weight percent to 0.7 weight percent sodium nitrate (NaNO₃), or from 0.25 weight percent to 0.65 weight percent NaNO₃, or even from 0.35 weight percent to 0.55 weight percent NaNO₃. In still another embodiment, the glass of the present invention comprises either no added coal or other carbon source (that is zero weight percent), or from 0.01 weight percent to 0.04 weight percent coal or other carbon source, or from 0.015 weight percent to 0.035 weight percent coal or other carbon source, or even from 0.02 weight percent to 0.03 weight percent coal or other carbon source. In still another embodiment, the glass of the present invention comprises 0.0005 weight percent (5 ppm) to 0.01 weight percent (100 ppm) Cr₂O₃, or from 0.001 weight percent (10 ppm) to 0.009 weight percent (90 ppm) Cr₂O₃, 0.002 weight percent (20 ppm) to 0.008 weight percent (80 ppm) Cr₂O₃, or even from 0.003 weight percent (30 ppm) to 0.007 weight percent (70 ppm) Cr₂O₃.

In still another embodiment, the glass of the present invention has a gray color as determined by the naked eye. In still another embodiment, the glass of the present invention is used in one or more of an architectural transparency or a vehicle transparency; or wherein the glass is used in one or more of an architectural transparency or a vehicle transparency, and wherein the architectural transparency or the vehicle transparency comprises one or more low-e coatings, one or more anti-reflective coatings, one or more solar control coatings, one or more low UV and/or IRC coatings, or combinations of any two or more thereof.

In still another embodiment, the present invention relates to a method of making a glass using a conventional float non-vacuum glass system, comprising the steps of melting a glass batch to provide a pool of molten glass; flowing the pool of molten glass onto a molten tin bath; moving the molten glass on the surface of the molten tin bath, while controllably cooling the molten glass and applying forces to the molten glass to provide a glass of a desired thickness; and removing the glass from the molten tin bath, wherein the glass comprises 64 weight percent to 75 weight percent SiO₂, or even 68 weight percent to 75 weight percent SiO₂; 10 weight percent to 20 weight percent Na₂O, or even 10 weight percent to 18 weight percent Na₂O; 5 weight percent to 15 weight percent CaO; 0 weight percent to 10 weight percent MgO; 0 weight percent to 5 weight percent Al₂O₃; 0 weight percent to 5 weight percent K₂O; 0 weight percent to 1 weight percent SO₃, or even 0.05 weight percent to 0.3 weight percent SO₃; and 1 weight percent to 3.5 weight percent total iron, preferably 1.25 weight percent to 3 weight percent total iron, or even more preferably 1.5 weight percent to 2.5 weight percent total iron, wherein the glass has a visible light transmission (T_{LA}) in the range of equal to or greater than 6 percent and equal to or less than 25 percent, or even equal to or greater than 7 percent and equal to or less than 24 percent, or even equal to or greater than 8 percent and equal to or less than 23 percent, or even equal to or greater than 9 percent and equal to or less than 22 percent, at a glass thickness of 3.85 mm via T_{LA} CIE Illuminant A across wavelengths 380 nm to 780 nm, an a* in the range of −4 to 0, or an a* in the range of −3.5 to −0.25, or an a* in the range of −3 to −0.5, or even an a* in the range of −2.5 to −0.75, and a b* in the range of −1 to 7, or a b* in the range of −0.5 to 6.5, or a b* in the range of 0 to 6, or even a b* in the range of 0.5 to 5.5. Here, as well as elsewhere in the specification, Examples, and claims, any one or more individual numerical values can be combined to form additional, or even new/non-disclosed, numerical ranges.

In another embodiment, the glass of this method of the present invention comprises a redox ratio in the range of 0.1 to 0.3. In still another embodiment, the glass of this method of the present invention comprises a redox ratio in the range of 0.13 to 0.28, or even in the range of 0.18 to 0.22.

In still another embodiment, the glass of this method of the present invention has an ultraviolet transmittance (T_{UV}) of equal to or less than 10 percent, of equal to or less than 9 percent, of equal to or less than 8 percent, of equal to or less than 7 percent, or even of equal to or less than 6 percent at a glass thickness of 3.85 mm at a wavelength range of 300 nm to 400 nm using the ISO 13837 standard. In still another embodiment, the glass of this method of the present invention has a direct solar energy transmission (T_{DS}) of equal to or less than 20 percent, equal to or less than 18 percent, equal to or less than 16 percent, or even equal to or less than 13 percent in the range of 300 to 2500 nm with intervals of 5, 10 and 50 nm, according to the ISO 13837 standard. In another embodiment, the glass has a T_{DS} in the range of 5 percent to 20 percent, or in the range of 6 percent to 18 percent, or even in the range of 7 percent to 15 percent in the range of 300 to 2500 nm with intervals of 5, 10 and 50 nm, according to the ISO 13837 standard.

In still another embodiment, the glass of this method of the present invention has a an infrared transmittance (T_{IR}) of equal to or less than 18 percent, equal to or less than 16 percent, equal to or less than 15 percent, equal to or less than 13 percent, equal to or less than 12 percent, equal to or less than 11 percent, or even equal to or less than 10 percent, when measured over the wavelength range of 800 nm to 2500 nm using the ISO 13837 standard. In still another embodiment, the glass of this method of the present invention has a total solar energy transmittance (T_{TS}) of equal to or less than 50 percent, of equal to or less than 45 percent, of equal to or less than 40 percent, of equal to or less than 35 percent, of equal to or less than 30 percent, of equal to or less than 25 percent, or even of equal to or less than 20 percent at a glass thickness of 3.85 mm is measured using the ISO 13837 standard. In still another embodiment, the glass of this method of the present invention has a dominant wavelength of 490 nm to 570 nm when it has a nominal thickness of 3.85 mm and is manufactured by a float process. In still another embodiment, the glass of this method of the present invention has a purity in the range of 0.4 percent to 12 percent, or in the range of 0.6 percent to 11 percent, or in the range of 0.8 percent to 10 percent, or in the range of even 1 percent to 9 percent.

In still another embodiment, the glass of this method of the present invention comprises 0.02 weight percent to 0.04 weight percent Co₃O₄, or from 0.021 weight percent to 0.039 weight percent Co₃O₄, or even from 0.022 weight percent to 0.038 weight percent Co₃O₄. In still another embodiment, the glass of this method of the present invention comprises 0.0001 weight percent to 0.02 weight percent CuO, or from 0.005 weight percent to 0.01 weight percent CuO, or even from 0.001 weight percent to 0.008 weight percent CuO. In still another embodiment, the glass of this method of the present invention comprises 0.002 weight percent to 0.005 weight percent selenium (Se), or from 0.0022 weight percent to 0.0045 weight percent selenium, or from 0.0024 weight percent to 0.004 weight percent selenium, or even from 0.0026 weight percent to 0.0035 weight percent selenium.

In still another embodiment, the glass of this method of the present invention comprises 0.01 weight percent to 0.15 weight percent TiO₂, or from 0.02 weight percent to 0.1 weight percent TiO₂, or even from 0.03 weight percent to 0.09 weight percent TiO₂. In still another embodiment, the glass of this method of the present invention comprises 0.25 weight percent to 0.5 weight percent FeO, or from 0.3 weight percent to 0.45 weight percent FeO, or even from 0.35 weight percent to 0.49 weight percent FeO. In still another embodiment, the glass of this method of the present invention comprises 0.1 weight percent to 0.25 weight percent SO₃, or from 0.12 weight percent to 0.23 weight percent SO₃, or even from 0.14 weight percent to 0.21 weight percent SO₃. In still another embodiment, the glass of this method of the present invention comprises 0.1 weight percent to 0.7 weight percent sodium nitrate (NaNO₃), or from 0.25 weight percent to 0.65 weight percent NaNO₃, or even from 0.35 weight percent to 0.55 weight percent NaNO₃. In still another embodiment, the glass of this method of the present invention comprises either no added coal or other carbon source (that is zero weight percent), or from 0.01 weight percent to 0.04 weight percent coal or other carbon source, or from 0.015 weight percent to 0.035 weight percent coal or other carbon source, or even from 0.02 weight percent to 0.03 weight percent coal or other carbon source. In still another embodiment, the glass of this method of the present invention comprises 0.0005 weight percent (5 ppm) to 0.01 weight percent (100 ppm) Cr₂O₃, or from 0.001 weight percent (10 ppm) to 0.009 weight percent (90 ppm) Cr₂O₃, 0.002 weight percent (20 ppm) to 0.008 weight percent (80 ppm) Cr₂O₃, or even from 0.003 weight percent (30 ppm) to 0.007 weight percent (70 ppm) Cr₂O₃.

In still another embodiment, the glass of this method of the present invention has a gray color as determined by the naked eye. In still another embodiment, the glass of this method of the present invention is used in one or more of an architectural transparency or a vehicle transparency; or wherein the glass is used in one or more of an architectural transparency or a vehicle transparency, and wherein the architectural transparency or the vehicle transparency comprises one or more low-e coatings, one or more anti-reflective coatings, one or more solar control coatings, one or more low UV and/or IRC coatings, or combinations of any two or more thereof.

In still another embodiment, the present invention relates to a laminate comprising a first ply comprising a first surface and a second surface opposite the first surface, wherein the first surface comprises an outer surface of the laminate; a second ply comprising a third surface adjacent the second surface and a fourth surface opposite the third surface, wherein the fourth surface comprises an inner surface of the laminate; and an interlayer positioned between the first ply and the second ply, wherein at least one of the first ply or second ply is formed from a glass comprising 64 weight percent to 75 weight percent SiO₂, or even 68 weight percent to 75 weight percent SiO₂; 10 weight percent to 20 weight percent Na₂O, or even 10 weight percent to 18 weight percent Na₂O; 5 weight percent to 15 weight percent CaO; 0 weight percent to 10 weight percent MgO; 0 weight percent to 5 weight percent Al₂O₃; 0 weight percent to 5 weight percent K₂O; 0 weight percent to 1 weight percent SO₃, or even 0.05 weight percent to 0.3 weight percent SO₃; and 1 weight percent to 3.5 weight percent total iron, preferably 1.25 weight percent to 3 weight percent total iron, or even more preferably 1.5 weight percent to 2.5 weight percent total iron, wherein the glass has a visible light transmission (T_{LA}) in the range of equal to or greater than 6 percent and equal to or less than 25 percent, or even equal to or greater than 7 percent and equal to or less than 24 percent, or even equal to or greater than 8 percent and equal to or less than 23 percent, or even equal to or greater than 9 percent and equal to or less than 22 percent, at a glass thickness of 3.85 mm via T_{L}A CIE Illuminant A across wavelengths 380 nm to 780 nm, an a* in the range of −4 to 0, or an a* in the range of −3.5 to −0.25, or an a* in the range of −3 to −0.5, or even an a* in the range of −2.5 to −0.75, and a b* in the range of −1 to 7, or a b* in the range of −0.5 to 6.5, or a b* in the range of 0 to 6, or even a b* in the range of 0.5 to 5.5. Here, as well as elsewhere in the specification, Examples, and claims, any one or more individual numerical values can be combined to form additional, or even new/non-disclosed, numerical ranges.

In still another embodiment, the present invention relates to any of the glasses, or glass compositions, described herein wherein such a glass has an ultraviolet transmittance (T_{UV}) in the range of equal to or greater than 1 percent and equal to or less than 6 percent, or alternatively equal to or greater than 1 percent and equal to or less than 10 percent. In still another embodiment, the present invention relates to any of the glasses, or glass compositions, described herein wherein such glass has a visible light transmission (T_{LA}) in the range of equal to or greater than 8 percent and equal to or less than 15 percent, or alternatively equal to or greater than 8 percent and equal to or less than 22 percent.

In still another embodiment, the present invention relates to any of the glasses, or glass compositions, described herein wherein such glass has a direct solar energy transmission (T_{DS}) in the range of equal to or greater than 7 percent and equal to or less than 13, or alternatively equal to or greater than 7 percent and equal to or less than 20 percent. In still another embodiment, the present invention relates to any of the glasses, or glass compositions, described herein wherein such glass has an infrared transmittance (T_{IR}) in the range of equal to or greater than 7 percent and equal to or less than 13, or alternatively equal to or greater than 7 percent and equal to or less than 18 percent.

In still another embodiment, the present invention relates to any of the glasses, or glass compositions, described herein wherein such glass has an infrared transmittance (T_{IR}) of equal to or less than 50 percent, or alternatively equal to or less than 35 percent, or alternatively in the range of equal to or greater than 30 percent and equal to or less than 50, or alternatively equal to or greater than 30 percent and equal to or less than 35 percent. In still another embodiment, the present invention relates to any of the glasses, or glass compositions, described herein wherein such glass has an L* in the range of 35 to 45, or an L* in the range of 36 to 44, or an L* in the range of 37 to 43, or an L* in the range of 38 to 42, or even an L* in the range of 39 to 41, or alternatively an L* in the range of 35 to 55, or an L* in the range of 36 to 54, or an L* in the range of 37 to 53, or an L* in the range of 38 to 52, or an L* in the range of 39 to 51, or an L* in the range of 40 to 50, or an L* in the range of 41 to 49, or an L* in the range of 42 to 48, or an L* in the range of 43 to 47, or even an L* in the range of 44 to 46.

The glass of this laminate can be formed from any of the various glasses disclosed herein where such a glass has any of the additional components and/or properties disclosed herein.

In still another embodiment, the present invention relates to a method of reducing visible light transmittance in a glass sheet comprising the steps of melting a glass batch to provide a pool of molten glass and cooling the molten glass batch to yield a molten glass, wherein the glass comprises 64 weight percent to 75 weight percent SiO₂, or even 68 weight percent to 75 weight percent SiO₂; 10 weight percent to 20 weight percent Na₂O, or even 10 weight percent to 18 weight percent Na₂O; 5 weight percent to 15 weight percent CaO; 0 weight percent to 10 weight percent MgO; 0 weight percent to 5 weight percent Al₂O₃; 0 weight percent to 5 weight percent K₂O; 0 weight percent to 1 weight percent SO₃, or even 0.05 weight percent to 0.3 weight percent SO₃; and 1 weight percent to 3.5 weight percent total iron, preferably 1.25 weight percent to 3 weight percent total iron, or even more preferably 1.5 weight percent to 2.5 weight percent total iron, wherein the glass has a visible light transmission (T_{LA}) in the range of equal to or greater than 6 percent and equal to or less than 25 percent, or even equal to or greater than 7 percent and equal to or less than 24 percent, or even equal to or greater than 8 percent and equal to or less than 23 percent, or even equal to or greater than 9 percent and equal to or less than 22 percent, at a glass thickness of 3.85 mm via T_{LA} CIE Illuminant A across wavelengths 380 nm to 780 nm, an a* in the range of −4 to 0, or an a* in the range of −3.5 to −0.25, or an a* in the range of −3 to −0.5, or even an a* in the range of −2.5 to −0.75, and a b* in the range of −1 to 7, or a b* in the range of −0.5 to 6.5, or a b* in the range of 0 to 6, or even a b* in the range of 0.5 to 5.5. Here, as well as elsewhere in the specification, Examples, and claims, any one or more individual numerical values can be combined to form additional, or even new/non-disclosed, numerical ranges.

The glass of this laminate can be formed from any of the various glasses disclosed herein where such a glass has any of the additional components and/or properties disclosed herein.

Regarding any numerical values disclosed in the specification (including any one or more numerical values from any one or more Examples in the Tables contained herein), be the individual values in one or more examples, or from one or more portions of a numerical range, any of these individual numerical values can be combined with any other numerical value of a similar nature to form a new and/or non-disclosed range. That is, for example, any individual redox numerical value can be combined with any other different redox numerical value to yield a new non-disclosed redox numerical range. Further, any individual numerical value from a given composition component, a given batch component, a given solar property, or even a given color property can be combined with any other different respective numerical value from a given composition component, a given batch component, a given solar property, or even a given color property to yield a new non-disclosed numerical range for one or more of a given composition component, a given batch component, a given solar property, or even a given color property.

As shown in the following Tables below, the following colorant formulations represent non-limiting embodiments for use in connection with any of the glass batch formulations described herein.

TABLE 1

| | | | | | |
|---|---|---|---|---|---|
| Example - Set A | 1a | 2a | 3a | 4a | 5a |

Colorants - Percent by Weight

| | | | | | |
|---|---|---|---|---|---|
| Fe₂O₃ | 1.67 | 1.72 | 1.73 | 1.77 | 1.77 |
| Co₃O₄ | 0.0246 | 0.0243 | 0.0246 | 0.0249 | 0.0290 |
| CuO | 0.0060 | 0.0060 | 0.0060 | 0.0060 | 0.0060 |
| Se | 0.0028 | 0.0026 | 0.0027 | 0.0027 | 0.0030 |
| TiO₂ | 0.028 | 0.028 | 0.028 | 0.028 | 0.028 |
| Cr₂O₃ | 0.0014 | 0.0012 | 0.0011 | 0.0022 | 0.0071 |
| FeO | 0.3657 | 0.3630 | 0.3608 | 0.3695 | 0.3749 |
| FeO (Expressed as Fe₂O₃) | 0.4064 | 0.4034 | 0.4010 | 0.4106 | 0.4166 |
| SO₃ | 0.1700 | 0.1730 | 0.1710 | 0.1710 | 0.1690 |
| Sodium Nitrate (NaNO₃) in Mixture | 0.53 | 0.53 | 0.53 | 0.53 | 0.53 |

Other Properties

| | | | | | |
|---|---|---|---|---|---|
| Redox Ratio | 0.2194 | 0.2116 | 0.2085 | 0.2091 | 0.2119 |
| Percent Ferrous (Percent Reduction) | 24.4 | 23.5 | 23.2 | 23.2 | 23.5 |

Solar Properties 3.85 mm (Percent)

| | | | | | |
|---|---|---|---|---|---|
| Ultraviolet Transmittance (T_{UV}) | 4.1 | 4.5 | 3.7 | 4.5 | 3.9 |
| Visible Light Illuminant Transmittance A (T_{LA}) | 12.4 | 13.8 | 10.8 | 14.2 | 12.1 |
| Direct Solar Transmittance (T_{DS}) | 12.0 | 12.8 | 11.4 | 12.7 | 11.6 |
| Infrared Transmittance (T_{IR}) | 11.3 | 11.5 | 11.5 | 11.2 | 10.8 |
| Total Solar Energy Transmittance (T_{TS}) | 34.5 | 34.9 | 34.4 | 34.7 | 34.2 |

Color Transmitted Illuminant D65 10° Obs (ASTM E308) 3.85 mm

| | | | | | |
|---|---|---|---|---|---|
| L* | 41.9 | 44.0 | 39.3 | 44.6 | 41.4 |
| a* | −2.6 | −2.4 | −2.6 | −2.5 | −2.7 |
| b* | 1.2 | 1.5 | 0.5 | 2.0 | 1.2 |

Illuminant C, 2° Obs

| | | | | | |
|---|---|---|---|---|---|
| Dominant Wavelength (nm) | 522.3 | 536.1 | 498.1 | 545.6 | 521.7 |
| Purity % | 1.6 | 2.0 | 1.7 | 2.8 | 1.7 |

TABLE 2

| | | | | | |
|---|---|---|---|---|---|
| Example - Set A | 6a | 7a | 8a | 9a | 10a |

Colorants - Percent by Weight

| | | | | | |
|---|---|---|---|---|---|
| Fe₂O₃ | 1.77 | 1.78 | 1.79 | 1.79 | 1.80 |
| Co₃O₄ | 0.0262 | 0.0264 | 0.0331 | 0.0313 | 0.0284 |
| CuO | 0.0060 | 0.0060 | 0.0060 | 0.0060 | 0.0060 |
| Se | 0.0028 | 0.0027 | 0.0032 | 0.0031 | 0.0029 |
| TiO₂ | 0.028 | 0.028 | 0.028 | 0.028 | 0.027 |
| Cr₂O₃ | 0.0036 | 0.0041 | 0.0118 | 0.0095 | 0.0064 |
| FeO | 0.3656 | 0.3765 | 0.3659 | 0.3731 | 0.3786 |
| FeO (Expressed as Fe₂O₃) | 0.4063 | 0.4184 | 0.4066 | 0.4146 | 0.4207 |
| SO₃ | 0.1700 | 0.1710 | 0.1700 | 0.1700 | 0.1680 |
| Sodium Nitrate (NaNO₃) in Mixture | 0.53 | 0.53 | 0.53 | 0.53 | 0.53 |

Other Properties

| | | | | | |
|---|---|---|---|---|---|
| Redox Ratio | 0.2062 | 0.2117 | 0.2048 | 0.2086 | 0.2108 |
| Percent Ferrous (Percent Reduction) | 22.9 | 23.5 | 22.8 | 23.2 | 23.4 |

Solar Properties 3.85 mm (Percent)

| | | | | | |
|---|---|---|---|---|---|
| Ultraviolet Transmittance (T_{UV}) | 4.2 | 4.0 | 3.6 | 3.7 | 3.7 |
| Visible Light Illuminant Transmittance A (T_{LA}) | 13.0 | 12.4 | 10.3 | 11.1 | 11.1 |
| Direct Solar Transmittance (T_{DS}) | 12.3 | 11.7 | 11.0 | 11.2 | 11.0 |
| Infrared Transmittance (T_{IR}) | 11.3 | 10.7 | 11.1 | 10.8 | 10.5 |
| Total Solar Energy Transmittance (T_{TS}) | 34.6 | 34.2 | 34.1 | 34.0 | 33.9 |

Color Transmitted Illuminant D65 10° Obs (ASTM E308) 3.85 mm

| | | | | | |
|---|---|---|---|---|---|
| L* | 42.8 | 41.9 | 38.5 | 39.8 | 39.9 |
| a* | −2.5 | −2.7 | −2.7 | −2.8 | −2.9 |
| b* | 1.5 | 1.5 | 0.2 | 0.7 | 0.9 |

Illuminant C, 2° Obs

| | | | | | |
|---|---|---|---|---|---|
| Dominant Wavelength (nm) | 536.7 | 531.8 | 494.0 | 502.6 | 505.2 |
| Purity % | 2.1 | 2.1 | 2.2 | 1.6 | 1.6 |

TABLE 3

| | | | | | |
|---|---|---|---|---|---|
| Example - Set A | 11a | 12a | 13a | 14a | 15a |

Colorants - Percent by Weight

| | | | | | |
|---|---|---|---|---|---|
| Fe₂O₃ | 1.82 | 1.82 | 1.83 | 1.86 | 1.86 |
| Co₃O₄ | 0.0344 | 0.0313 | 0.0315 | 0.0356 | 0.0351 |
| CuO | 0.0060 | 0.0060 | 0.0060 | 0.0060 | 0.0060 |
| Se | 0.0033 | 0.0030 | 0.0031 | 0.0030 | 0.0032 |
| TiO₂ | 0.028 | 0.027 | 0.028 | 0.028 | 0.028 |
| Cr₂O₃ | 0.0136 | 0.0089 | 0.0096 | 0.0148 | 0.0143 |
| FeO | 0.3752 | 0.3784 | 0.3664 | 0.3601 | 0.3715 |
| FeO (Expressed as Fe₂O₃) | 0.4170 | 0.4205 | 0.4072 | 0.4002 | 0.4128 |
| SO₃ | 0.1700 | 0.1670 | 0.1700 | 0.1670 | 0.1660 |
| Sodium Nitrate (NaNO₃) in Mixture | 0.53 | 0.53 | 0.53 | 0.53 | 0.53 |

Other Properties

| | | | | | |
|---|---|---|---|---|---|
| Redox Ratio | 0.2061 | 0.2075 | 0.2001 | 0.1932 | 0.1993 |
| Percent Ferrous (Percent Reduction) | 22.9 | 23.1 | 22.2 | 21.5 | 22.2 |

Solar Properties 3.85 mm (Percent)

| | | | | | |
|---|---|---|---|---|---|
| Ultraviolet Transmittance (T_{UV}) | 3.1 | 3.3 | 3.5 | 3.6 | 3.2 |
| Visible Light Illuminant Transmittance A (T_{LA}) | 8.8 | 9.7 | 10.1 | 10.3 | 9.0 |
| Direct Solar Transmittance (T_{DS}) | 10.1 | 10.4 | 10.9 | 11.2 | 10.2 |
| Infrared Transmittance (T_{IR}) | 10.6 | 10.5 | 11.1 | 11.5 | 10.8 |
| Total Solar Energy Transmittance (T_{TS}) | 33.5 | 33.6 | 34.1 | 34.3 | 33.7 |

Color Transmitted Illuminant D65 10° Obs (ASTM E308) 3.85 mm

| | | | | | |
|---|---|---|---|---|---|
| L* | 35.8 | 37.5 | 38.2 | 38.5 | 36.1 |
| a* | −2.9 | −2.9 | −2.7 | −2.6 | −2.8 |
| b* | 0.0 | 0.2 | 0.2 | 0.4 | 0.0 |

Illuminant C, 2° Obs

| | | | | | |
|---|---|---|---|---|---|
| Dominant Wavelength (nm) | 491.1 | 493.5 | 493.6 | 497.3 | 491.3 |
| Purity % | 2.8 | 2.4 | 2.2 | 1.8 | 2.8 |

TABLE 4

| | | | | |
|---|---|---|---|---|
| Example - Set A | 16a | 17a | 18a | 19a |

Colorants - Percent by Weight

| | | | | |
|---|---|---|---|---|
| Fe₂O₃ | 2.03 | 2.06 | 2.10 | 2.30 |
| Co₃O₄ | 0.0349 | 0.0356 | 0.0377 | 0.0330 |
| CuO | 0.0065 | 0.0065 | 0.0065 | 0.0075 |
| Se | 0.0031 | 0.0032 | 0.0033 | 0.0042 |
| TiO₂ | 0.031 | 0.030 | 0.031 | 0.056 |
| Cr₂O₃ | 0.0009 | 0.0009 | 0.0009 | 0.0013 |
| FeO | 0.3799 | 0.4070 | 0.3705 | 0.3196 |
| FeO (Expressed as Fe₂O₃) | 0.4222 | 0.4523 | 0.4117 | 0.3551 |
| SO₃ | 0.1550 | 0.1600 | 0.1600 | 0.2030 |
| Sodium Nitrate (NaNO₃) in Mixture | 0.56 | 0.53 | 0.56 | 0.66 |

Other Properties

| | | | | |
|---|---|---|---|---|
| Redox Ratio | 0.1868 | 0.1975 | 0.1764 | 0.1389 |
| Percent Ferrous (Percent Reduction) | 20.8 | 21.9 | 19.6 | 15.4 |

Solar Properties 3.85 mm (Percent)

| | | | | |
|---|---|---|---|---|
| Ultraviolet Transmittance (T_{UV}) | 3.1 | 2.5 | 3.3 | 1.5 |
| Visible Light Illuminant Transmittance A (T_{LA}) | 11.4 | 9.8 | 11.9 | 10.2 |
| Direct Solar Transmittance (T_{DS}) | 11.1 | 9.7 | 11.6 | 10.6 |
| Infrared Transmittance (T_{IR}) | 10.6 | 9.2 | 11.1 | 11.4 |
| Total Solar Energy Transmittance (T_{TS}) | 33.9 | 32.9 | 34.3 | 33.7 |

Color Transmitted Illuminant D65 10° Obs (ASTM E308) 3.85 mm

| | | | | |
|---|---|---|---|---|
| L* | 40.3 | 37.5 | 41.0 | 37.9 |
| a* | −2.4 | −2.7 | −2.3 | −2.9 |
| b* | 1.6 | 1.4 | 1.5 | 6.0 |

Illuminant C, 2° Obs

| | | | | |
|---|---|---|---|---|
| Dominant Wavelength (nm) | 538.1 | 526.9 | 539.7 | 576.4 |
| Purity % | 2.3 | 2.0 | 2.2 | 11.9 |

TABLE 5

| | | | | | |
|---|---|---|---|---|---|
| Example - Set B | 1b | 2b | 3b | 4b | 5b |

Colorants - Percent by Weight

| | | | | | |
|---|---|---|---|---|---|
| Fe₂O₃ | 1.29 | 1.35 | 1.35 | 1.37 | 1.41 |
| Co₃O₄ | 0.0228 | 0.0228 | 0.0221 | 0.0215 | 0.0235 |
| CuO | 0.0001 | 0.0001 | 0.0001 | 0.0001 | 0.0001 |
| Se | 0.0027 | 0.0027 | 0.0027 | 0.0025 | 0.0028 |
| TiO₂ | 0.090 | 0.103 | 0.089 | 0.033 | 0.031 |
| Cr₂O₃ | 0.0008 | 0.0008 | 0.0007 | 0.0008 | 0.0005 |
| FeO | 0.3180 | 0.3290 | 0.3296 | 0.3850 | 0.330 |
| FeO (Expressed as Fe₂O₃) | 0.3534 | 0.3656 | 0.3663 | 0.4279 | 0.3667 |
| SO₃ | 0.1570 | 0.1590 | 0.1560 | 0.1070 | 0.142 |
| Sodium Nitrate (NaNO₃) in Mixture | 0.40 | 0.40 | 0.40 | 0.40 | 0.16 |
| Coal/Carbon Source | 0.01 | 0.01 | 0.01 | 0.01 | 0.034 |

Other Properties

| | | | | | |
|---|---|---|---|---|---|
| Redox Ratio | 0.2465 | 0.2443 | 0.2438 | 0.2805 | 0.2343 |
| Percent Ferrous (Percent Reduction) | 27.4 | 27.2 | 27.1 | 31.2 | 26.0 |

Solar Properties 3.85 mm (Percent)

| | | | | | |
|---|---|---|---|---|---|
| Ultraviolet Transmittance (T_{UV}) | 8.5 | 8.1 | 7.8 | 8.6 | 8.5 |
| Visible Light Illuminant Transmittance A (T_{LA}) | 19.4 | 19.1 | 19.6 | 19.0 | 18.7 |
| Direct Solar Transmittance (T_{DS}) | 17.2 | 16.6 | 16.7 | 14.8 | 16.5 |
| Infrared Transmittance (T_{IR}) | 14.6 | 13.8 | 13.8 | 10.3 | 13.7 |
| Total Solar Energy Transmittance (T_{TS}) | 37.8 | 37.3 | 37.2 | 35.4 | 37.3 |

Color Transmitted Illuminant D65 10° Obs (ASTM E308) 3.85 mm

| | | | | | |
|---|---|---|---|---|---|
| L* | 51.1 | 50.8 | 51.2 | 50.7 | 50.3 |
| a* | −0.7 | −1.0 | −0.9 | −1.2 | −0.5 |
| b* | 0.4 | 0.8 | 1.7 | 0.6 | 0.0 |

Illuminant C, 2° Obs

| | | | | | |
|---|---|---|---|---|---|
| Dominant Wavelength (nm) | 527.9 | 548.7 | 561.6 | 529.4 | 490.4 |
| Purity % | 0.4 | 1.1 | 2.5 | 0.7 | 0.4 |
| Furnace Atmosphere | Air/gas | Air/gas | Air/gas | Oxi | Oxi |

TABLE 6

| | | | | | |
|---|---|---|---|---|---|
| Example - Set B | 6b | 7b | 8b | 9b | 10b |

Colorants - Percent by Weight

| | | | | | |
|---|---|---|---|---|---|
| Fe₂O₃ | 1.41 | 1.41 | 1.46 | 1.49 | 1.52 |
| Co₃O₄ | 0.0220 | 0.0234 | 0.0246 | 0.0219 | 0.0241 |
| CuO | 0.0006 | 0.0001 | 0.0006 | 0.0007 | 0.0015 |
| Se | 0.0024 | 0.0027 | 0.0027 | 0.0028 | 0.0026 |
| TiO₂ | 0.029 | 0.029 | 0.029 | 0.028 | 0.028 |
| Cr₂O₃ | 0.0035 | 0.0005 | 0.0037 | 0.0041 | 0.0087 |
| FeO | 0.3161 | 0.333 | 0.3068 | 0.3060 | 0.3132 |
| FeO (Expressed as Fe₂O₃) | 0.3513 | 0.3698 | 0.3409 | 0.3401 | 0.3481 |
| SO₃ | 0.1860 | 0.138 | 0.1650 | 0.1650 | 0.1510 |
| Sodium Nitrate (NaNO₃) in Mixture | 0.40 | 0.16 | 0.56 | 0.56 | 0.56 |
| Coal/Carbon Source | 0.00 | 0.034 | 0.00 | 0.00 | 0.00 |

Other Properties

| | | | | | |
|---|---|---|---|---|---|
| Redox Ratio | 0.2238 | 0.2352 | 0.2104 | 0.2056 | 0.2062 |
| Percent Ferrous (Percent Reduction) | 24.9 | 26.1 | 23.4 | 22.9 | 22.9 |

Solar Properties 3.85 mm (Percent)

| | | | | | |
|---|---|---|---|---|---|
| Ultraviolet Transmittance (T_{UV}) | 7.6 | 8.4 | 8.1 | 8.1 | 7.0 |
| Visible Light Illuminant Transmittance A (T_{LA}) | 19.2 | 19.0 | 20.4 | 20.7 | 19.0 |
| Direct Solar Transmittance (T_{DS}) | 17.1 | 16.5 | 18.0 | 18.1 | 17.0 |
| Infrared Transmittance (T_{IR}) | 14.8 | 13.4 | 15.6 | 15.6 | 15.0 |
| Total Solar Energy Transmittance (T_{TS}) | 37.7 | 37.2 | 38.3 | 38.4 | 37.6 |

Color Transmitted Illuminant D65 10° Obs (ASTM E308) 3.85 mm

| | | | | | |
|---|---|---|---|---|---|
| L* | 50.9 | 50.6 | 52.2 | 52.6 | 50.7 |
| a* | −1.4 | −0.8 | −1.5 | −1.5 | −2.4 |
| b* | 1.4 | −0.2 | 1.5 | 2.0 | 2.0 |

Illuminant C, 2° Obs

| | | | | | |
|---|---|---|---|---|---|
| Dominant Wavelength (nm) | 551.0 | 486.9 | 553.4 | 558.0 | 547.5 |
| Purity % | 1.9 | 0.8 | 2.1 | 2.8 | 2.7 |
| Furnace Atmosphere | Air/gas | Oxi | Air/gas | Air/gas | Air/gas |

TABLE 7

| | | | | | |
|---|---|---|---|---|---|
| Example - Set B | 11b | 12b | 13b | 14b | 15b |

Colorants - Percent by Weight

| | | | | | |
|---|---|---|---|---|---|
| Fe₂O₃ | 1.52 | 1.52 | 1.53 | 1.54 | 1.55 |
| Co₃O₄ | 0.0237 | 0.0238 | 0.0231 | 0.0234 | 0.0235 |
| CuO | 0.0009 | 0.0010 | 0.0008 | 0.0008 | 0.0009 |
| Se | 0.0027 | 0.0027 | 0.0029 | 0.0026 | 0.0028 |
| TiO₂ | 0.029 | 0.029 | 0.029 | 0.028 | 0.029 |
| Cr₂O₃ | 0.0057 | 0.0059 | 0.0049 | 0.0049 | 0.0053 |
| FeO | 0.3232 | 0.3140 | 0.3064 | 0.3100 | 0.2980 |
| FeO (Expressed as Fe₂O₃) | 0.3592 | 0.3489 | 0.3405 | 0.3445 | 0.3312 |
| SO₃ | 0.1550 | 0.1520 | 0.1590 | 0.1580 | 0.1580 |
| Sodium Nitrate (NaNO₃) in Mixture | 0.56 | 0.56 | 0.56 | 0.56 | 0.56 |
| Coal/Carbon Source | 0.00 | 0.00 | 0.00 | 0.00 | 0.00 |

Other Properties

| | | | | | |
|---|---|---|---|---|---|
| Redox Ratio | 0.2125 | 0.2060 | 0.2009 | 0.2017 | 0.1927 |
| Percent Ferrous (Percent Reduction) | 23.6 | 22.9 | 22.3 | 22.4 | 21.4 |

Solar Properties 3.85 mm (Percent)

| | | | | | |
|---|---|---|---|---|---|
| Ultraviolet Transmittance (T_{UV}) | 6.6 | 6.9 | 6.4 | 6.6 | 6.5 |
| Visible Light Illuminant Transmittance A (T_{LA}) | 18.9 | 19.0 | 18.7 | 18.9 | 18.9 |
| Direct Solar Transmittance (T_{DS}) | 16.4 | 16.9 | 17.0 | 17.0 | 17.5 |
| Infrared Transmittance (T_{IR}) | 14.2 | 14.9 | 15.5 | 15.2 | 16.2 |
| Total Solar Energy Transmittance (T_{TS}) | 37.2 | 37.6 | 37.8 | 37.7 | 38.2 |

Color Transmitted Illuminant D65 10° Obs (ASTM E308) 3.85 mm

| | | | | | |
|---|---|---|---|---|---|
| L* | 50.5 | 50.6 | 50.1 | 50.5 | 50.4 |
| a* | −2.3 | −2.3 | −1.3 | −1.8 | −1.4 |
| b* | 2.4 | 2.1 | 3.1 | 2.5 | 2.9 |

Illuminant C, 2° Obs

| | | | | | |
|---|---|---|---|---|---|
| Dominant Wavelength (nm) | 553.2 | 550.1 | 563.6 | 558.3 | 562.6 |
| Purity % | 3.3 | 2.8 | 4.8 | 3.6 | 4.4 |
| Furnace Atmosphere | Air/gas | Air/gas | Air/gas | Air/gas | Air/gas |

TABLE 8

| | | | | | |
|---|---|---|---|---|---|
| Example - Set B | 16b | 17b | 18b | 19b | 20b |

Colorants - Percent by Weight

| | | | | | |
|---|---|---|---|---|---|
| Fe₂O₃ | 1.55 | 1.55 | 1.55 | 1.56 | 1.56 |
| Co₃O₄ | 0.0238 | 0.0241 | 0.0242 | 0.0242 | 0.0235 |
| CuO | 0.0011 | 0.0009 | 0.0007 | 0.0060 | 0.0011 |
| Se | 0.0026 | 0.0029 | 0.0028 | 0.0029 | 0.0026 |
| TiO₂ | 0.030 | 0.029 | 0.029 | 0.029 | 0.029 |
| Cr₂O₃ | 0.0064 | 0.0055 | 0.0045 | 0.0014 | 0.0063 |
| FeO | 0.3161 | 0.3026 | 0.3171 | 0.3603 | 0.3273 |
| FeO (Expressed as Fe₂O₃) | 0.3513 | 0.3363 | 0.3524 | 0.4004 | 0.3637 |
| SO₃ | 0.1480 | 0.1520 | 0.1550 | 0.1820 | 0.1500 |
| Sodium Nitrate (NaNO₃) in Mixture | 0.56 | 0.56 | 0.56 | 0.53 | 0.56 |
| Coal/Carbon Source | 0.00 | 0.00 | 0.00 | 0.00 | 0.00 |

Other Properties

| | | | | | |
|---|---|---|---|---|---|
| Redox Ratio | 0.2042 | 0.1948 | 0.2040 | 0.2315 | 0.2096 |
| Percent Ferrous (Percent Reduction) | 22.7 | 21.6 | 22.7 | 25.7 | 23.3 |

Solar Properties 3.85 mm (Percent)

| | | | | | |
|---|---|---|---|---|---|
| Ultraviolet Transmittance (T_{UV}) | 6.8 | 6.2 | 6.4 | 4.1 | 6.4 |
| Visible Light Illuminant Transmittance A (T_{LA}) | 18.9 | 18.5 | 18.6 | 11.9 | 18.5 |
| Direct Solar Transmittance (T_{DS}) | 16.8 | 17.1 | 16.6 | 12.0 | 16.1 |
| Infrared Transmittance (T_{IR}) | 14.8 | 15.8 | 14.7 | 11.6 | 13.9 |
| Total Solar Energy Transmittance (T_{TS}) | 37.5 | 37.9 | 37.4 | 34.6 | 37.0 |

Color Transmitted Illuminant D65 10° Obs (ASTM E308) 3.85 mm

| | | | | | |
|---|---|---|---|---|---|
| L* | 50.5 | 49.9 | 50.1 | 41.1 | 50.1 |
| a* | −1.9 | −1.4 | −1.8 | −2.5 | −2.3 |
| b* | 2.3 | 3.0 | 2.5 | 0.9 | 2.4 |

Illuminant C, 2° Obs

| | | | | | |
|---|---|---|---|---|---|
| Dominant Wavelength (nm) | 555.6 | 563.1 | 558.5 | 508.7 | 553.5 |
| Purity % | 3.3 | 4.7 | 3.7 | 1.4 | 3.4 |
| Furnace Atmosphere | Air/gas | Air/gas | Air/gas | Air/gas | Air/gas |

TABLE 9

| | | | | | |
|---|---|---|---|---|---|
| Example - Set B | 21b | 22b | 23b | 24b | 25b |

Colorants - Percent by Weight

| | | | | | |
|---|---|---|---|---|---|
| Fe₂O₃ | 1.56 | 1.57 | 1.57 | 1.57 | 1.58 |
| Co₃O₄ | 0.0237 | 0.0243 | 0.0247 | 0.0240 | 0.0243 |
| CuO | 0.0011 | 0.0011 | 0.0011 | 0.0008 | 0.0008 |
| Se | 0.0025 | 0.0027 | 0.0026 | 0.0029 | 0.0027 |
| TiO₂ | 0.030 | 0.030 | 0.029 | 0.030 | 0.028 |
| Cr₂O₃ | 0.0064 | 0.0065 | 0.0064 | 0.0050 | 0.0050 |
| FeO | 0.3267 | 0.3317 | 0.3253 | 0.3106 | 0.3171 |
| FeO (Expressed as Fe₂O₃) | 0.3631 | 0.3686 | 0.3615 | 0.3452 | 0.3524 |
| SO₃ | 0.1480 | 0.1460 | 0.1500 | 0.1610 | 0.1570 |
| Sodium Nitrate (NaNO₃) in Mixture | 0.56 | 0.56 | 0.56 | 0.56 | 0.56 |
| Coal/Carbon Source | 0.00 | 0.00 | 0.00 | 0.00 | 0.00 |

Other Properties

| | | | | | |
|---|---|---|---|---|---|
| Redox Ratio | 0.2090 | 0.2119 | 0.2074 | 0.1972 | 0.2006 |
| Percent Ferrous (Percent Reduction) | 23.2 | 23.5 | 23.0 | 21.9 | 22.3 |

Solar Properties 3.85 mm (Percent)

| | | | | | |
|---|---|---|---|---|---|
| Ultraviolet Transmittance (T_{UV}) | 6.6 | 6.4 | 6.5 | 6.4 | 6.3 |
| Visible Light Illuminant Transmittance A (T_{LA}) | 18.6 | 18.1 | 18.4 | 18.5 | 18.5 |
| Direct Solar Transmittance (T_{DS}) | 16.2 | 15.8 | 16.2 | 16.8 | 16.5 |
| Infrared Transmittance (T_{IR}) | 14.0 | 13.6 | 14.1 | 15.2 | 14.7 |
| Total Solar Energy Transmittance (T_{TS}) | 37.0 | 36.7 | 37.1 | 37.6 | 37.3 |

Color Transmitted Illuminant D65 10° Obs (ASTM E308) 3.85 mm

| | | | | | |
|---|---|---|---|---|---|
| L* | 50.3 | 49.6 | 50.0 | 49.9 | 50.0 |
| a* | −2.4 | −2.3 | −2.4 | −1.4 | −1.8 |
| b* | 2.0 | 2.2 | 1.8 | 2.8 | 2.5 |

Illuminant C, 2° Obs

| | | | | | |
|---|---|---|---|---|---|
| Dominant Wavelength (nm) | 546.6 | 550.6 | 544.3 | 562.4 | 557.4 |
| Purity % | 2.6 | 3.0 | 2.3 | 4.4 | 3.6 |
| Furnace Atmosphere | Air/gas | Air/gas | Air/gas | Air/gas | Air/gas |

TABLE 10

| | | | | | |
|---|---|---|---|---|---|
| Example - Set B | 26b | 27b | 28b | 29b | 30b |

Colorants - Percent by Weight

| | | | | | |
|---|---|---|---|---|---|
| Fe₂O₃ | 1.67 | 1.72 | 1.73 | 1.77 | 1.77 |
| Co₃O₄ | 0.0246 | 0.0243 | 0.0246 | 0.0249 | 0.0290 |
| CuO | 0.0060 | 0.0060 | 0.0060 | 0.0060 | 0.0060 |
| Se | 0.0028 | 0.0026 | 0.0027 | 0.0027 | 0.0030 |
| TiO₂ | 0.028 | 0.028 | 0.028 | 0.028 | 0.028 |
| Cr₂O₃ | 0.0014 | 0.0012 | 0.0011 | 0.0022 | 0.0071 |
| FeO | 0.3657 | 0.3630 | 0.3608 | 0.3695 | 0.3749 |
| FeO (Expressed as Fe₂O₃) | 0.4064 | 0.4034 | 0.4010 | 0.4106 | 0.4166 |
| SO₃ | 0.1700 | 0.1730 | 0.1710 | 0.1710 | 0.1690 |
| Sodium Nitrate (NaNO₃) in Mixture | 0.53 | 0.53 | 0.53 | 0.53 | 0.53 |
| Coal/Carbon Source | 0.00 | 0.00 | 0.00 | 0.00 | 0.00 |

Other Properties

| | | | | | |
|---|---|---|---|---|---|
| Redox Ratio | 0.2194 | 0.2116 | 0.2085 | 0.2091 | 0.2119 |
| Percent Ferrous (Percent Reduction) | 24.4 | 23.5 | 23.2 | 23.2 | 23.5 |

Solar Properties 3.85 mm (Percent)

| | | | | | |
|---|---|---|---|---|---|
| Ultraviolet Transmittance (T_{UV}) | 4.1 | 4.5 | 3.7 | 4.5 | 3.9 |
| Visible Light Illuminant Transmittance A (T_{LA}) | 12.4 | 13.8 | 10.8 | 14.2 | 12.1 |
| Direct Solar Transmittance (T_{DS}) | 12.0 | 12.8 | 11.4 | 12.7 | 11.6 |
| Infrared Transmittance (T_{IR}) | 11.3 | 11.5 | 11.5 | 11.2 | 10.8 |
| Total Solar Energy Transmittance (T_{TS}) | 34.5 | 34.9 | 34.4 | 34.7 | 34.2 |

Color Transmitted Illuminant D65 10° Obs (ASTM E308) 3.85 mm

| | | | | | |
|---|---|---|---|---|---|
| L* | 41.9 | 44.0 | 39.3 | 44.6 | 41.4 |
| a* | −2.6 | −2.4 | −2.6 | −2.5 | −2.7 |
| b* | 1.2 | 1.5 | 0.5 | 2.0 | 1.2 |

Illuminant C, 2° Obs

| | | | | | |
|---|---|---|---|---|---|
| Dominant Wavelength (nm) | 522.3 | 536.1 | 498.1 | 545.6 | 521.7 |
| Purity % | 1.6 | 2.0 | 1.7 | 2.8 | 1.7 |
| Furnace Atmosphere | Air/gas | Air/gas | Air/gas | Air/gas | Air/gas |

TABLE 11

| | | | | | |
|---|---|---|---|---|---|
| Example - Set B | 31b | 32b | 33b | 34b | 35b |

Colorants - Percent by Weight

| | | | | | |
|---|---|---|---|---|---|
| Fe₂O₃ | 1.77 | 1.78 | 1.79 | 1.79 | 1.80 |
| Co₃O₄ | 0.0262 | 0.0264 | 0.0331 | 0.0313 | 0.0284 |
| CuO | 0.0060 | 0.0060 | 0.0060 | 0.0060 | 0.0060 |
| Se | 0.0028 | 0.0027 | 0.0032 | 0.0031 | 0.0029 |
| TiO₂ | 0.028 | 0.028 | 0.028 | 0.028 | 0.027 |
| Cr₂O₃ | 0.0036 | 0.0041 | 0.0118 | 0.0095 | 0.0064 |
| FeO | 0.3656 | 0.3765 | 0.3659 | 0.3731 | 0.3786 |
| FeO (Expressed as Fe₂O₃) | 0.4063 | 0.4184 | 0.4066 | 0.4146 | 0.4207 |
| SO₃ | 0.1700 | 0.1710 | 0.1700 | 0.1700 | 0.1680 |
| Sodium Nitrate (NaNO₃) in Mixture | 0.53 | 0.53 | 0.53 | 0.53 | 0.53 |
| Coal/Carbon Source | 0.00 | 0.00 | 0.00 | 0.00 | 0.00 |

Other Properties

| | | | | | |
|---|---|---|---|---|---|
| Redox Ratio | 0.2062 | 0.2117 | 0.2048 | 0.2086 | 0.2108 |
| Percent Ferrous (Percent Reduction) | 22.9 | 23.5 | 22.8 | 23.2 | 23.4 |

Solar Properties 3.85 mm (Percent)

| | | | | | |
|---|---|---|---|---|---|
| Ultraviolet Transmittance (T_{UV}) | 4.2 | 4.0 | 3.6 | 3.7 | 3.7 |
| Visible Light Illuminant Transmittance A (T_{LA}) | 13.0 | 12.4 | 10.3 | 11.1 | 11.1 |
| Direct Solar Transmittance (T_{DS}) | 12.3 | 11.7 | 11.0 | 11.2 | 11.0 |
| Infrared Transmittance (T_{IR}) | 11.3 | 10.7 | 11.1 | 10.8 | 10.5 |
| Total Solar Energy Transmittance (T_{TS}) | 34.6 | 34.2 | 34.1 | 34.0 | 33.9 |

Color Transmitted Illuminant D65 10° Obs (ASTM E308) 3.85 mm

| | | | | | |
|---|---|---|---|---|---|
| L* | 42.8 | 41.9 | 38.5 | 39.8 | 39.9 |
| a* | −2.5 | −2.7 | −2.7 | −2.8 | −2.9 |
| b* | 1.5 | 1.5 | 0.2 | 0.7 | 0.9 |

Illuminant C, 2° Obs

| | | | | | |
|---|---|---|---|---|---|
| Dominant Wavelength (nm) | 536.7 | 531.8 | 494.0 | 502.6 | 505.2 |
| Purity % | 2.1 | 2.1 | 2.2 | 1.6 | 1.6 |
| Furnace Atmosphere | Air/gas | Air/gas | Air/gas | Air/gas | Air/gas |

TABLE 12

| | | | | | |
|---|---|---|---|---|---|
| Example - Set B | 36b | 37b | 38b | 39b | 40b |

Colorants - Percent by Weight

| | | | | | |
|---|---|---|---|---|---|
| Fe₂O₃ | 1.82 | 1.82 | 1.83 | 1.86 | 1.86 |
| Co₃O₄ | 0.0344 | 0.0313 | 0.0315 | 0.0356 | 0.0351 |
| CuO | 0.0060 | 0.0060 | 0.0060 | 0.0060 | 0.0060 |
| Se | 0.0033 | 0.0030 | 0.0031 | 0.0030 | 0.0032 |
| TiO₂ | 0.028 | 0.027 | 0.028 | 0.028 | 0.028 |
| Cr₂O₃ | 0.0136 | 0.0089 | 0.0096 | 0.0148 | 0.0143 |
| FeO | 0.3752 | 0.3784 | 0.3664 | 0.3601 | 0.3715 |
| FeO (Expressed as Fe₂O₃) | 0.4170 | 0.4205 | 0.4072 | 0.4002 | 0.4128 |
| SO₃ | 0.1700 | 0.1670 | 0.1700 | 0.1670 | 0.1660 |
| Sodium Nitrate (NaNO₃) in Mixture | 0.53 | 0.53 | 0.53 | 0.53 | 0.53 |
| Coal/Carbon Source | 0.00 | 0.00 | 0.00 | 0.00 | 0.00 |

Other Properties

| | | | | | |
|---|---|---|---|---|---|
| Redox Ratio | 0.2061 | 0.2075 | 0.2001 | 0.1932 | 0.1993 |
| Percent Ferrous (Percent Reduction) | 22.9 | 23.1 | 22.2 | 21.5 | 22.2 |

Solar Properties 3.85 mm (Percent)

| | | | | | |
|---|---|---|---|---|---|
| Ultraviolet Transmittance (T_{UV}) | 3.1 | 3.3 | 3.5 | 3.6 | 3.2 |
| Visible Light Illuminant Transmittance A (T_{LA}) | 8.8 | 9.7 | 10.1 | 10.3 | 9.0 |
| Direct Solar Transmittance (T_{DS}) | 10.1 | 10.4 | 10.9 | 11.2 | 10.2 |
| Infrared Transmittance (T_{IR}) | 10.6 | 10.5 | 11.1 | 11.5 | 10.8 |
| Total Solar Energy Transmittance (T_{TS}) | 33.5 | 33.6 | 34.1 | 34.3 | 33.7 |

Color Transmitted Illuminant D65 10° Obs (ASTM E308) 3.85 mm

| | | | | | |
|---|---|---|---|---|---|
| L* | 35.8 | 37.5 | 38.2 | 38.5 | 36.1 |
| a* | −2.9 | −2.9 | −2.7 | −2.6 | −2.8 |
| b* | 0.0 | 0.2 | 0.2 | 0.4 | 0.0 |

Illuminant C, 2° Obs

| | | | | | |
|---|---|---|---|---|---|
| Dominant Wavelength (nm) | 491.1 | 493.5 | 493.6 | 497.3 | 491.3 |
| Purity % | 2.8 | 2.4 | 2.2 | 1.8 | 2.8 |
| Furnace Atmosphere | Air/gas | Air/gas | Air/gas | Air/gas | Air/gas |

TABLE 13

| | | | |
|---|---|---|---|
| Example - Set B | 41b | 42b | 43b |

Colorants - Percent by Weight

| | | | |
|---|---|---|---|
| Fe₂O₃ | 2.03 | 2.06 | 2.10 |
| Co₃O₄ | 0.0349 | 0.0356 | 0.0377 |
| CuO | 0.0065 | 0.0065 | 0.0065 |
| Se | 0.0031 | 0.0032 | 0.0033 |
| TiO₂ | 0.031 | 0.030 | 0.031 |
| Cr₂O₃ | 0.0009 | 0.0009 | 0.0009 |
| FeO | 0.3799 | 0.4070 | 0.3705 |
| FeO (Expressed as Fe₂O₃) | 0.4222 | 0.4523 | 0.4117 |
| SO₃ | 0.1550 | 0.1600 | 0.1600 |
| Sodium Nitrate (NaNO₃) in Mixture | 0.56 | 0.53 | 0.56 |
| Coal/Carbon Source | 0.00 | 0.00 | 0.00 |

Other Properties

| | | | |
|---|---|---|---|
| Redox Ratio | 0.1868 | 0.1975 | 0.1764 |
| Percent Ferrous (Percent Reduction) | 20.8 | 21.9 | 19.6 |

Solar Properties 3.85 mm (Percent)

| | | | |
|---|---|---|---|
| Ultraviolet Transmittance (T_{UV}) | 3.1 | 2.5 | 3.3 |
| Visible Light Illuminant Transmittance A (T_{LA}) | 11.4 | 9.8 | 11.9 |
| Direct Solar Transmittance (T_{DS}) | 11.1 | 9.7 | 11.6 |
| Infrared Transmittance (T_{IR}) | 10.6 | 9.2 | 11.1 |
| Total Solar Energy Transmittance (T_{TS}) | 33.9 | 32.9 | 34.3 |

Color Transmitted Illuminant D65 10° Obs (ASTM E308) 3.85 mm

| | | | |
|---|---|---|---|
| L* | 40.3 | 37.5 | 41.0 |
| a* | −2.4 | −2.7 | −2.3 |
| b* | 1.6 | 1.4 | 1.5 |

Illuminant C, 2° Obs

| | | | |
|---|---|---|---|
| Dominant Wavelength (nm) | 538.1 | 526.9 | 539.7 |
| Purity % | 2.3 | 2.0 | 2.2 |
| Furnace Atmosphere | Air/gas | Air/gas | Air/gas |

Regarding the various solar properties in Tables 1 to 13 above, note the following T_{UV} values are determined via ISO 13837, air mass 1.5, wavelength range 300 nm to 400 nm; T_{IR} values are determined via ISO 13837 air mass 1.5, wavelength range 800 nm to 2500 nm; T_{TS} values are determined via ISO 13837, v=4 m/sec; and T_{LA} values are determined via CIE Illuminant A wavelength range 380 nm to 780 nm.

In order to reach the proposed properties for a glass composition, according to the scope of the invention, other variations may be applied without departing from what is described in the claims that follow. Accordingly, the particular embodiments described in detail herein are illustrative only and are not limiting as to the scope of the invention, which is to be given the full breadth of the appended claims and any and all equivalents thereof.

What is claimed is:

1. A glass comprising:
SiO₂ 64 to 75 weight percent, or 68 to 75 weight percent;
Na₂O 10 to 20 weight percent, or even 10 to 18 weight percent;
CaO 5 to 15 weight percent;
MgO 0 to 10 weight percent;
Al₂O₃ 0 to 5 weight percent;
K₂O 0 to 5 weight percent;
SO3 0 to 1 weight percent, or even 0.05 to 0.3 weight percent; and
Total Iron 1 to 3.5 weight percent, preferably 1.25 to 3 weight percent, or even more preferably 1.5 to 2.5 weight percent,
wherein the glass has a visible light transmission (T_{LA}) in the range of equal to or greater than 6 percent and equal to or less than 25 percent, or even equal to or greater than 7 percent and equal to or less than 24 percent, or even equal to or greater than 8 percent and equal to or less than 23 percent, or even equal to or greater than 9 percent and equal to or less than 22 percent, at a glass thickness of 3.85 mm via T_{LA} CIE Illuminant A across wavelengths 380 nm to 780 nm, an a* in the range of −4 to 0, or an a* in the range of −3.5 to −0.25, or an a* in the range of −3 to −0.5, or even an a* in the range of −2.5 to −0.75, and a b* in the range of −1 to 7, or a b* in the range of −0.5 to 6.5, or a b* in the range of 0 to 6, or even a b* in the range of 0.5 to 5.5.

2. The glass of claim 1, wherein the glass comprises a redox ratio in the range of 0.1 to 0.3.

3. The glass of claim 1, wherein the glass comprises a redox ratio in the range of 0.13 to 0.28, or even in the range of 0.18 to 0.22.

4. The glass of claim 1, wherein the glass has an ultraviolet transmittance (T_{UV}) of equal to or less than 10 percent, of equal to or less than 9 percent, of equal to or less than 8 percent, of equal to or less than 7 percent, or even of equal to or less than 6 percent at a glass thickness of 3.85 mm at a wavelength range of 300 nm to 400 nm using the ISO 13837 standard.

5. The glass of claim 1, wherein the glass has a direct solar energy transmission (T_{DS}) of equal to or less than 20 percent, equal to or less than 18 percent, equal to or less than 16 percent, or even equal to or less than 13 percent in the range of 300 to 2500 nm with intervals of 5, 10 and 50 nm, according to the ISO 13837 standard, or even the glass of any of claims 1 to 4 has a T_{DS} in the range of 5 percent to 20 percent, or in the range of 6 percent to 18 percent, or even in the range of 7 percent to 15 percent in the range of 300 to 2500 nm with intervals of 5, 10 and 50 nm, according to the ISO 13837 standard.

6. The glass of claim 1, wherein the glass has an infrared transmittance (T_{IR}) of equal to or less than 18 percent, equal to or less than 16 percent, equal to or less than 15 percent, equal to or less than 13 percent, equal to or less than 12 percent, equal to or less than 11 percent, or even equal to or less than 10 percent, when measured over the wavelength range of 800 nm to 2500 nm using the ISO 13837 standard.

7. The glass of claim 1, wherein the glass has a total solar energy transmittance (T_{TS}) of equal to or less than 50 percent, of equal to or less than 45 percent, of equal to or less than 40 percent, of equal to or less than 35 percent, of equal to or less than 30 percent, of equal to or less than 25 percent, or even of equal to or less than 20 percent at a glass thickness of 3.85 mm, when measured using the ISO 13837 standard.

8. The glass of claim 1, wherein the glass has a dominant wavelength of 490 nm to 570 nm when it has a nominal thickness of 3.85 mm and is manufactured by a float process.

9. The glass of claim 1, wherein the glass has a purity in the range of 0.4 percent to 12 percent, or in the range of 0.6 percent to 11 percent, or in the range of 0.8 percent to 10 percent, or even in the range of 1 percent to 9 percent.

10. The glass of claim 1, wherein the glass further comprises 0.02 weight percent to 0.04 weight percent Co₃O₄, or from 0.021 weight percent to 0.039 weight percent Co₃O₄, or even from 0.022 weight percent to 0.038 weight percent Co₃O₄.

11. The glass of claim 1, wherein the glass further comprises 0.0001 weight percent to 0.02 weight percent CuO, or from 0.005 weight percent to 0.01 weight percent CuO, or even from 0.001 weight percent to 0.008 weight percent CuO.

12. The glass of claim 1, wherein the glass further comprises 0.002 weight percent to 0.005 weight percent selenium (Se), or from 0.0022 weight percent to 0.0045 weight percent selenium, or from 0.0024 weight percent to 0.004 weight percent selenium, or even from 0.0026 weight percent to 0.0035 weight percent selenium.

13. The glass claim 1, wherein the glass further comprises 0.01 weight percent to 0.15 weight percent TiO₂, or from 0.02 weight percent to 0.1 weight percent TiO₂, or even from 0.03 weight percent to 0.09 weight percent TiO₂.

14. The glass of claim 1, wherein the glass further comprises 0.25 weight percent to 0.5 weight percent FeO, or from 0.3 weight percent to 0.45 weight percent FeO, or even from 0.35 weight percent to 0.49 weight percent FeO.

15. The glass of claim 1, wherein the glass further comprises 0.1 weight percent to 0.25 weight percent SO₃, or from 0.12 weight percent to 0.23 weight percent SO₃, or even from 0.14 weight percent to 0.21 weight percent SO₃.

16. The glass of claim 1, wherein the glass further comprises 0.1 weight percent to 0.7 weight percent sodium nitrate (NaNO₃), or from 0.25 weight percent to 0.65 weight percent NaNO₃, or even from 0.35 weight percent to 0.55 weight percent NaNO₃.

17. The glass of claim 1, wherein the glass further comprises either no added coal or other carbon source (that is zero weight percent), or from 0.01 weight percent to 0.04 weight percent coal or other carbon source, or from 0.015 weight percent to 0.035 weight percent coal or other carbon source, or even from 0.02 weight percent to 0.03 weight percent coal or other carbon source.

18. The glass of claim 1, wherein the glass further comprises 0.0005 weight percent (5 ppm) to 0.01 weight percent (100 ppm) Cr₂O₃, or from 0.001 weight percent (10 ppm) to 0.009 weight percent (90 ppm) Cr₂O₃, 0.002 weight percent (20 ppm) to 0.008 weight percent (80 ppm) Cr₂O₃, or even from 0.003 weight percent (30 ppm) to 0.007 weight percent (70 ppm) Cr₂O₃.

19. A method of making a glass using a conventional float non-vacuum glass system, comprising the steps of:
melting a glass batch to provide a pool of molten glass;
flowing the pool of molten glass onto a molten tin bath;
moving the molten glass on the surface of the molten tin bath, while controllably cooling the molten glass and applying forces to the molten glass to provide a glass of a desired thickness; and
removing the glass from the molten tin bath, wherein the glass comprises:
SiO₂ 64 to 75 weight percent, or 68 to 75 weight percent;
Na₂O 10 to 20 weight percent, or even 10 to 18 weight percent;
CaO 5 to 15 weight percent;
MgO 0 to 10 weight percent;
Al₂O₃ 0 to 5 weight percent;
K₂O 0 to 5 weight percent;
SO3 0 to 1 weight percent, or even 0.05 to 0.3 weight percent; and
Total Iron 1 to 3.5 weight percent, preferably 1.25 to 3 weight percent, or even more preferably 1.5 to 2.5 weight percent,
wherein the glass has a visible light transmission (T_{LA}) in the range of equal to or greater than 6 percent and equal to or less than 25 percent, or even equal to or greater than 7 percent and equal to or less than 24 percent, or even equal to or greater than 8 percent and equal to or less than 23 percent, or even equal to or greater than 9 percent and equal to or less than 22 percent, at a glass thickness of 3.85 mm via T_{LA} CIE Illuminant A across wavelengths 380 nm to 780 nm, an a* in the range of −4 to 0, or an a* in the range of −3.5 to −0.25, or an a* in the range of −3 to −0.5, or even an a* in the range of −2.5 to −0.75, and a b* in the range of −1 to 7, or a b* in the range of −0.5 to 6.5, or a b* in the range of 0 to 6, or even a b* in the range of 0.5 to 5.5.

20. A laminate comprising a first ply comprising:
a first surface and a second surface opposite the first surface, wherein the first surface comprises an outer surface of the laminate;
a second ply comprising a third surface adjacent the second surface and a fourth surface opposite the third surface, wherein the fourth surface comprises:
an inner surface of the laminate; and
an interlayer positioned between the first ply and the second ply, wherein at least one of the first ply or second ply is formed from a glass comprising:
SiO₂ 64 to 75 weight percent, or 68 to 75 weight percent;
Na₂O 10 to 20 weight percent, or even 10 to 18 weight percent;
CaO 5 to 15 weight percent;
MgO 0 to 10 weight percent;
Al₂O₃ 0 to 5 weight percent;
K₂O 0 to 5 weight percent;
SO3 0 to 1 weight percent, or even 0.05 to 0.3 weight percent; and
Total Iron 1 to 3.5 weight percent, preferably 1.25 to 3 weight percent, or even more preferably 1.5 to 2.5 weight percent,
wherein the glass has a visible light transmission (T_{LA}) in the range of equal to or greater than 6 percent and equal to or less than 25 percent, or even equal to or greater than 7 percent and equal to or less than 24 percent, or even equal to or greater than 8 percent and equal to or less than 23 percent, or even equal to or greater than 9 percent and equal to or less than 22 percent, at a glass thickness of 3.85 mm via T_{L}A CIE Illuminant A across wavelengths 380 nm to 780 nm, an a* in the range of −4 to 0, or an a* in the range of −3.5 to −0.25, or an a* in the range of −3 to −0.5, or even an a* in the range of −2.5 to −0.75, and a b* in the range of −1 to 7, or a b* in the range of −0.5 to 6.5, or a b* in the range of 0 to 6, or even a b* in the range of 0.5 to 5.5.
